(19) United States
(12) Patent Application Publication
(10) Pub. No.: US 2025/0055660 A1
(43) Pub. Date: Feb. 13, 2025

(54) TRANSMISSIONS AND RECEPTIONS IN FULL-DUPLEX SYSTEMS

(71) Applicant: Samsung Electronics Co., Ltd., Suwon-si (KR)

(72) Inventors: Marian Rudolf, Longueuil (CA); Aristides Papasakellariou, Houston, TX (US); Emad Nader Farag, Flanders, NJ (US)

(21) Appl. No.: 18/781,919

(22) Filed: Jul. 23, 2024

Related U.S. Application Data
(60) Provisional application No. 63/532,261, filed on Aug. 11, 2023.

(51) Int. Cl. H04L 5/14; H04W 72/0453; H04W 72/1268; H04W 72/1273; H04W 72/231; H04W 76/20

(52) U.S. Cl. CPC H04L 5/14; H04W 72/0453; H04W 72/1268; H04W 72/1273; H04W 72/231; H04W 76/20

(57) ABSTRACT

Methods and apparatuses for transmissions and receptions in full-duplex systems. A method of operating a user equipment (UE) includes receiving a first candidate subband full-duplex (SBFD) configuration associated with a first transmission configuration indicator (TCI) state configuration on a cell; receiving a second candidate SBFD configuration associated with a second TCI state configuration on the cell; and identifying a TCI state code point. The method further includes selecting (i) the first candidate SBFD configuration when a value of the TCI state code point is associated with the first TCI state configuration or (ii) the second candidate SBFD configuration when the value of the TCI state code point is associated with the second TCI state configuration and receiving or transmitting a channel or signal based on the selected SBFD configuration.

### CROSS-REFERENCE TO RELATED APPLICATIONS AND CLAIM OF PRIORITY

The present application claims priority to U.S. Provisional Patent Application No. 63/532,261, filed on Aug. 11, 2023. The contents of the above-identified patent documents are incorporated herein by reference.

### TECHNICAL FIELD

The present disclosure relates generally to wireless communication systems and, more specifically, the present disclosure relates to transmissions and receptions in full-duplex systems in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to transmissions and receptions in full-duplex systems in a wireless communication system.

In one embodiment, a method of operating a user equipment (UE) is provided. The method includes receiving a first candidate subband full-duplex (SBFD) configuration associated with a first transmission configuration indicator (TCI) state configuration on a cell; receiving a second candidate SBFD configuration associated with a second TCI state configuration on the cell; and identifying a TCI state code point. The method further includes selecting (i) the first candidate SBFD configuration when a value of the TCI state code point is associated with the first TCI state configuration or (ii) the second candidate SBFD configuration when the value of the TCI state code point is associated with the second TCI state configuration and receiving or transmitting a channel or signal based on the selected SBFD configuration. The value of the TCI state code point is from a set of values associated with a set of transmit-receive points (TRPs).

In another embodiment, a UE is provided. The UE includes a transceiver configured to receive a first candidate SBFD configuration associated with a first TCI state configuration on a cell and receive a second candidate SBFD configuration associated with a second TCI state configuration on the cell. The UE further includes a processor operably coupled to the transceiver. The processor is configured to identify a TCI state code point and select (i) the first candidate SBFD configuration when a value of the TCI state code point is associated with the first TCI state configuration or (ii) the second candidate SBFD configuration when the value of the TCI state code point is associated with the second TCI state configuration. The transceiver is further configured to receive or transmit a channel or signal based on the selected SBFD configuration. The value of the TCI state code point is from a set of values associated with a set of TRPs.

In yet another embodiment, a base station (BS) is provided. The BS includes a transceiver configured to transmit a first candidate SBFD configuration associated with a first TCI state configuration on a cell; transmit a second candidate SBFD configuration associated with a second TCI state configuration on the cell; and receive or transmit a channel or signal associated with a SBFD configuration. The SBFD configuration is from (i) the first candidate SBFD configuration when a value of a TCI state code point is associated with the first TCI state configuration or (ii) the second candidate SBFD configuration when the value of the TCI state code point is associated with the second TCI state configuration. The value of the TCI state code point is from a set of values associated with a set of TRPs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of a base station (gNB) according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of antenna structure according to embodiments of the present disclosure;

FIG. 7 illustrates an example of structure of slots for a time division duplex (TDD) communications systems according to embodiments of the present disclosure;

FIG. 8 illustrates an example of structure of slots for full-duplex (FD) configurations according to embodiments of the present disclosure;

FIG. 9 illustrates a flowchart of UE method for a determination of an SBFD configuration based on a TCI state for mTRP operation in a full-duplex communication according to embodiments of the present disclosure;

FIG. 10 illustrates a flowchart of UE method for a determination of a set of TCI states based on SBFD configuration for mTRP operation in a full-duplex communication system according to embodiments of the present disclosure; and

FIG. 11 illustrates a flowchart of UE method for an indication of restricted SBFD configuration for mTRP operation in a full-duplex communication system according to embodiments of the present disclosure.

### DETAILED DESCRIPTION

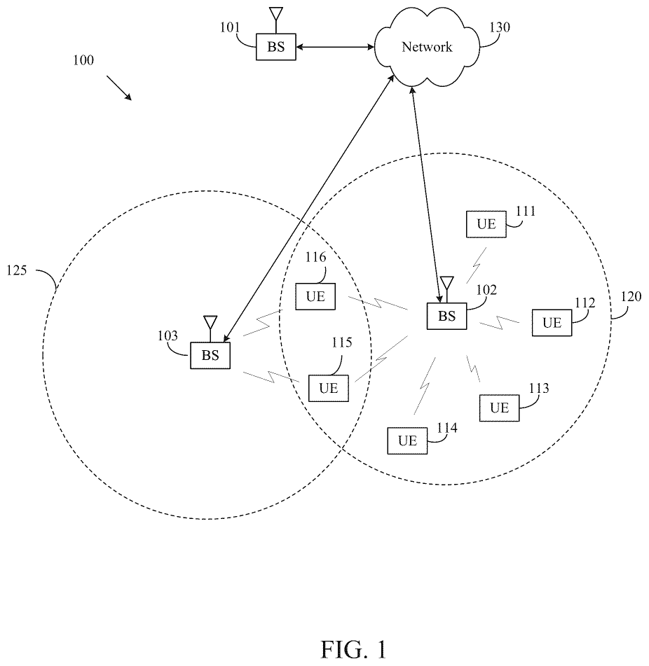

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 36.211 v17.5.0, “E-UTRA, Physical channels and modulation”; 3GPP TS 36.212 v17.5.0, “E-UTRA, Multiplexing and Channel coding”; 3GPP TS 36.213 v17.6.0, “E-UTRA, Physical Layer Procedures”; 3GPP TS 38.214 v17.6.0, “NR, Physical Layer Procedures for Data”; 3GPP TS 38.321 v17.5.0, “NR, Medium Access Control (MAC) protocol specification”; and 3GPP TS 38.331 v17.5.0, “NR, Radio Resource Control (RRC) Protocol Specification.” 3GPP TS 38.133 v17.10.0, “NR; Requirements for support of radio resource management”; 3GPP TS 38.300 v17.5.0, “NR; NR and NG-RAN Overall Description; Stage 2”; 3GPP TS 38.306 v17.5.0, “NR; User Equipment (UE) radio access capabilities”; 3GPP TR 38.858 v0.4.1, “Study on evolution of NR duplex operation”; and 3GPP TS 38.822 v17.1.0, “NR; User Equipment (UE) feature list.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for transmissions and receptions in full-duplex systems. In certain embodiments, and one or more of the gNBs 101-103 includes circuitry, programing, or a combination thereof, to support transmissions and receptions in full-duplex systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

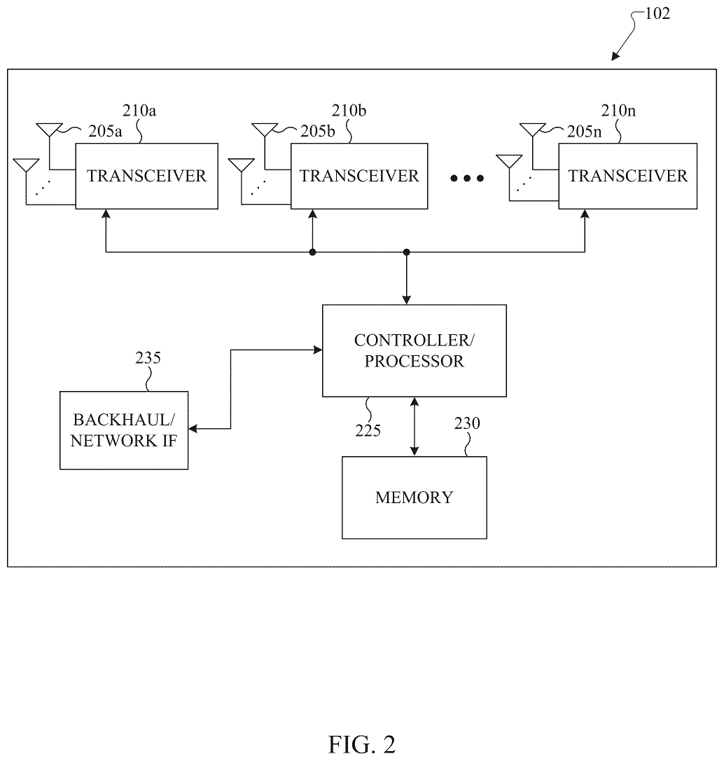

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support transmissions and receptions in full-duplex systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

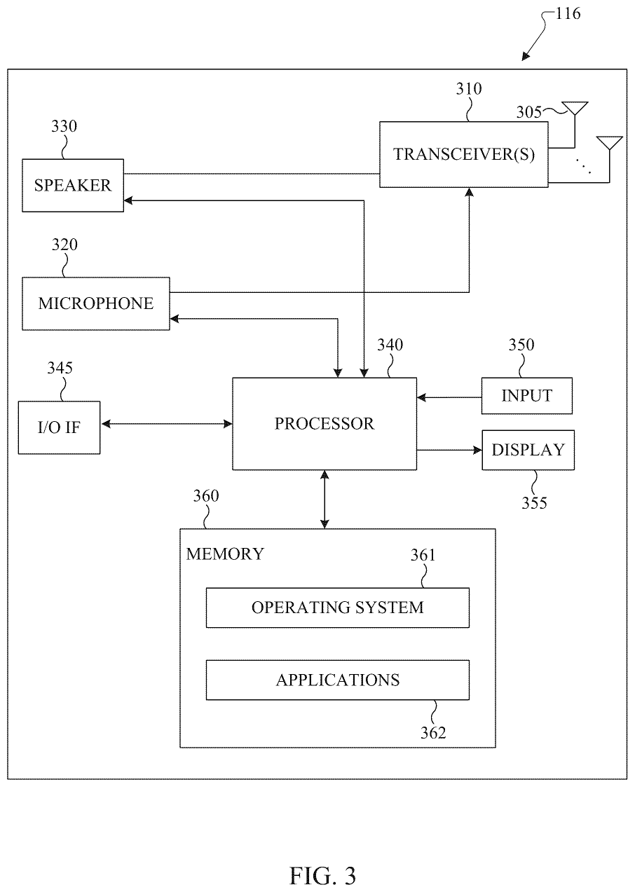

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for transmissions and receptions in full-duplex systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

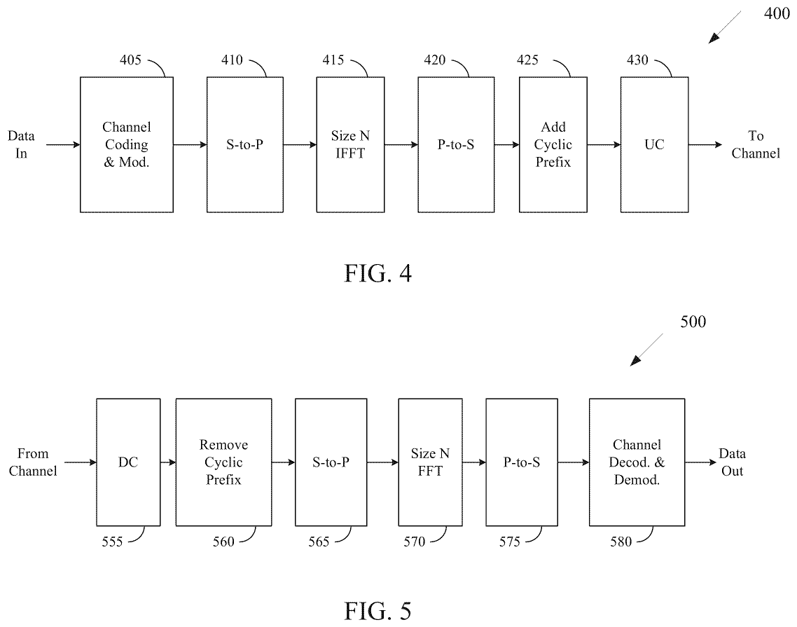

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the transmit path 400 is configured to support transmissions and the receive path 500 is configured to support receptions in full-duplex systems.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A communication system can include a downlink (DL) that refers to transmissions from a base station (e.g., 101-103 as illustrated in FIG. 1) or one or more transmission points to UEs (e.g., 111-116 as illustrated in FIG. 1) and an uplink (UL) that refers to transmissions from UEs (e.g., 111-116 as illustrated in FIG. 1) to a base station (e.g., 101-103 as illustrated in FIG. 1) or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A DCI format scheduling PDSCH reception or PUSCH transmission for a single UE, such as a DCI format with CRC scrambled by C-RNTI/CS-RNTI/MCS-C-RNTI as described in 3GPP standard specification, are referred for brevity as a unicast DCI format. A DCI format scheduling PDSCH reception for multicast communication, such as a DCI format with CRC scrambled by G-RNTI/G-CS-RNTI as described in 3GPP standard specification, are referred to as multicast DCI format. DCI formats providing various control information to at least a subset of UEs in a serving cell, such as DCI format 2_0 in 3GPP standard specification, are referred to as group-common (GC) DCI formats.

A gNB transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In some embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also 3GPP standard specification NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in 3GPP NR standard specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

A UE may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or CSI-RS and a target reference signal, or a spatial relationship information that establishes an association to a source reference signal, such as an SSB, CSI-RS, or SRS. In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a TCI state of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M TCI State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a QCL relationship between one or two downlink reference signals and the DM-RS ports of the PDSCH, the DM-RS port of PDCCH or the CSI-RS port(s) of a CSI-RS resource.

A QCL relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI states with N elements. In one example, DL and joint TCI states are configured by higher layer parameter DLorJoint-TCIState, wherein, the number of DL and Joint TCI state is N_{DJ}. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the PCI of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell); additionally, the UL TCI states can be associated with a cell having a PCI different from the PCI of the serving cell, e.g., the source RS of the TCI state is associated with a cell having a PCI different from the PCI of the serving cell.

A MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS and the CSI-RS has the SSB as its source, e.g., for a QCL Type D relation or a spatial relation. The indirect QCL relation to an SSB can involve a QCL or spatial relation chain of more than one CSI-RS.

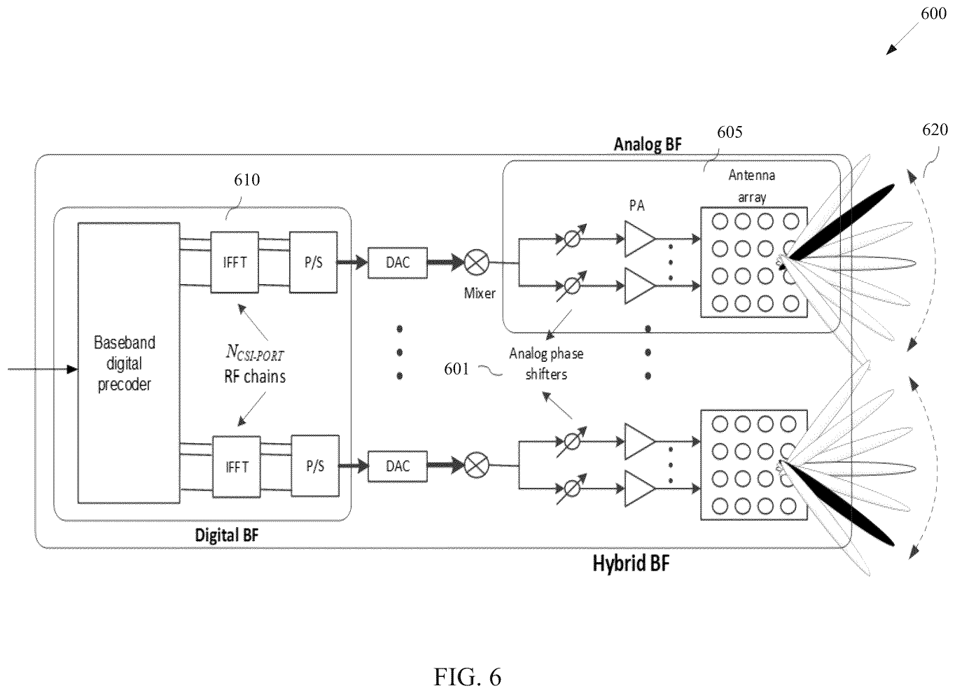

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example antenna structure 600 according to embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

For a cellular system operation in a sub-1 GHz frequency range (e.g., less than 1 GHz), supporting large number of CSI-RS antenna ports (e.g., 32) at a single location or remote radio head (RRH) or TRP is challenging due to that a larger antenna form factor size is needed at these frequencies than a system operating at a higher frequency such as 2 GHz or 4 GHz. At such low frequencies, the maximum number of CSI-RS antenna ports that can be co-located at a single site (or TRP/RRH) can be limited, for example to 8. This limits the spectral efficiency of such systems. In particular, the MU-MIMO spatial multiplexing gains offered due to large number of CSI-RS antenna ports (such as 32) cannot be achieved.

One way to operate a sub-1 GHz system with large number of CSI-RS antenna ports is based on distributing antenna ports at multiple locations (or TRP/RRHs). The multiple sites or TRPs/RRHs can still be connected to a single (common) base unit, hence the signal transmitted/received via multiple distributed TRPs/RRHs can still be processed at a centralized location. This is called distributed MIMO or multi-TRP coherent joint transmission (C-JT).

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed.

For example, CSI or calibration coefficient reporting band can include all the subbands within the DL system bandwidth. This can also be termed “full-band.” Alternatively, CSI or calibration coefficient reporting band can include only a collection of subbands within the DL system bandwidth. This can also be termed “partial band.” The term “CSI reporting band” is used only as an example for representing a function. Other terms such as “CSI reporting subband set” or “CSI or calibration coefficient reporting bandwidth” can also be used.

In terms of a UE configuration, a UE can be configured with at least one CSI or calibration coefficient reporting band. This configuration can be semi-static (via higher layer signaling or RRC) or dynamic (via MAC CE or Li DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mₙ subbands within the CSI reporting band. A CSI parameter is configured with “subband” for the CSI reporting band with Mn subbands when one CSI parameter is reported for each of the Mn subbands within the CSI reporting band.

In some embodiments, 5G NR radio supports time-division duplex (TDD) operation and frequency division duplex (FDD) operation. Use of FDD or TDD depends on the NR frequency band and per-country allocations. TDD is required in most bands above 2.5 GHz.

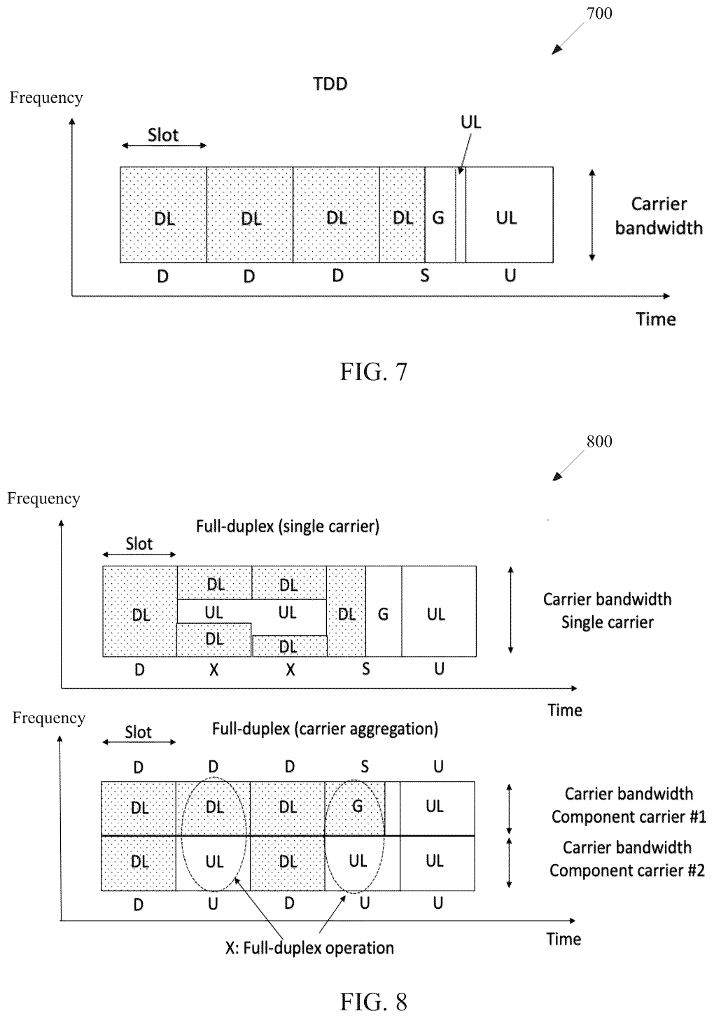

FIG. 7 illustrates an example of structure of slots for a TDD communications systems 700 according to embodiments of the present disclosure. An embodiment of the structure of slots for a TDD communications systems 700 shown in FIG. 7 is for illustration only.

A DDDSU UL-DL configuration is shown in FIG. 7. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL considering an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD all time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network to forgo HARQ-ACK information at least for some transport blocks in the DL).

To address some of the disadvantages for TDD operation, an adaptation of link direction based on physical layer signaling using a DCI format is supported where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in 3GPP standard specification, that can indicate a link direction of some flexible symbols in one or more slots. Nevertheless, in actual deployments, it is difficult for a gNB scheduler to adapt a transmission direction of symbols without coordination with other gNB schedulers in the network. This is because of CLI where, for example, DL receptions in a cell by a UE can experience large interference from UL transmissions in the same or neighboring cells from other UEs.

Full-duplex (FD) communications offer a potential for increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap.

A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. Full-duplex operation using an UL subband or a DL subband may be referred to as subband-full-duplex (SBFD).

For example, when a full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as “DU” or “UD,” respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, DL subbands and one UL subband on the full-duplex slot or symbol. A frequency-domain configuration of the DL and UL subbands may then be referred to as “DUD” when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols.

Instead of using a single carrier, it is also possible to use different component carriers (CCs) for receptions and transmissions by a UE. For example, receptions by a UE can occur on a first CC and transmissions by the UE occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

An FD transmission/reception is not limited to gNBs, TRPs, or UEs, but can also be used for other types of wireless nodes such as relay or repeater nodes.

Embodiments of the present invention recognize that a full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the present disclosure, the term FD is used as a short form for a full-duplex operation in a wireless system. The terms “cross-division-duplex” (XDD), “full duplex” and “subband-full-duplex” may be used interchangeably in the disclosure.

An FD operation in NR can improve spectral efficiency, link robustness, capacity, and latency of UL transmissions. In an NR TDD system, transmissions from a UE are limited by fewer available transmission opportunities than receptions by the UE. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any transmission from the UE can only occur in a limited number of UL slots, for example every 2, 2.5, or 5 msec, respectively.

FIG. 8 illustrates an example of FDD configurations 800 according to embodiments of the present disclosure. An embodiment of the FDD configurations 800 shown in FIG. 8 is for illustration only.

For a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot, possibly in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB 102 uses DL slots for scheduling transmissions from the UE 116 using full-duplex transmission and reception at the gNB 102, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB 102 uses UL slots for purpose of scheduling transmissions to UEs using full-duplex transmission and reception at the gNB 102, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB/UE, and S slots that are used for both transmission and receptions by the gNB/UE and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation.

Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

Rel-15 NR focuses on single TRP-based transmission/reception with ideal backhaul from UE perspective.

Using Rel-16 NR, a serving cell can schedule the UE from two TRPs, providing better coverage, reliability and/or data rates for PDSCH, PDCCH, PUSCH, and PUCCH in multiple transmit/receive point (multi-TRP or mTRP) operation. There are two different operation modes to schedule multi-TRP PDSCH transmissions: single-DCI (or sDCI) and multi-DCI (or mDCI). For both modes, control of UL and DL operation can be done by the physical layer and MAC, within the configuration provided by RRC. In single-DCI mode, the UE is scheduled by a same DCI for receptions from or transmissions to both TRPs. In a multi-DCI mode, the UE is scheduled by a separate DCI from each TRP. For example, to improve DL date rate, both single-DCI and multi-DCI based non-coherent joint transmission (NCJT) can be supported.

With reference to procedures according to Rel-16 NR, for multi-DCI-based NCJT transmission, up to 4 transmission layers per PDSCH, a UE may expect to receive two PDCCHs scheduling two fully/partially/non-overlapped PDSCHs respectively in time and frequency domain with same/different PDSCH scrambling ID(s). When the UE is scheduled with fully or partially overlapping PDSCHs, the UE is not expected to assume DM-RS ports in a CDM group indicated by two TCI states. Some configurations related to two received PDSCHs, e.g., active BWP, etc. are expected to be same from UE perspective. The UE can be expected to rate match around configured CRS patterns which are associated with the value of CORESETPoolIndex, i.e., per TRP basis, and applied to the corresponding PDSCH.

For PDCCH monitoring, two TRPs are implicitly associated with two CORESET groups, i.e., up to 3 CORESETs per TRP, respectively each of which can be identified by the value of CORESETPoolIndex. The maximum number of BDs/non-overlapping CCEs for a scheduling cell can be doubled for two TRPs but the maximum number of BDs/non-overlapping CCEs per TRP remains same as in Rel.15 NR.

A scheduling timeline can be relaxed to support out-of-order PDCCH to PDSCH, PDSCH to HARQ-ACK, and PDCCH to PUSCH depending on UE capability considering different backhaul conditions between two TRPs. Both intra-slot separated HARQ-ACK (per TRP basis) and joint HARQ-ACK feedback (across two TRPs) can be supported and specified as by 3GPP standard specification for Type-1 and Type-2 HARQ-ACK codebook in order to facilitate different backhaul conditions. The maximum number of active TCI states in a serving cell can be doubled by independent activation from two TRPs but the maximum number of active TCI states per TRP remains the same as in Rel.15 NR.

For example, the following examples of transmission schemes are supported with single-DCI and configured by higher layer signaling.

In one example of “FDMSchemeA,” when two TCI states, i.e., two TRPs, are indicated in a DCI and the UE is set to “FDMSchemeA,” the UE receives a single PDSCH transmission occasion of the TB with each TCI state associated to a non-overlapping frequency domain resource allocation in a manner of comb-like PRGs allocation (or half/half for wideband).

In another example of “FDMSchemeB,” when two TCI states, i.e., two TRPs, are indicated in a DCI and the UE is set to “FDMSchemeB,” the UE receives two PDSCH transmission occasions of the same TB with each TCI state associated to non-overlapping frequency domain resource allocation in a manner of comb-like PRGs allocation (or half/half for wideband).

In yet another example of “TDMSchemeA” (intra-slot), when two TCI states are indicated in a DCI and the UE is set to “TDMSchemeA,” the UE receives two PDSCH transmission occasions of the same TB with each TCI state associated to a PDSCH transmission occasion which has non-overlapping time domain resource allocation with respect to the other PDSCH transmission occasion. Both PDSCH transmission occasions corresponding to two TRPs, respectively, with mapping Type B are received within a given slot with a symbol-level gap configured by StartingSymbolOffsetK.

In yet another example of “repetitionNumber-r16” (inter-slot), when a UE is configured by the higher layer parameter repetitionNumber-r16 in PDSCH-TimeDomainResourceAllocation-r16, the UE may expect to be indicated with one or two TCI states in a codepoint of the TCI field. When two TCI states are indicated in a DCI, the UE may expect to receive multiple slot level PDSCH transmission occasions of the same TB with two TCI states associated to repetitionNumber-r16 consecutive slots (up to 16). Each PDSCH transmission occasion is expected to have the same SLIV. The UE may be configured with either cyclicMapping or sequentialMapping for given TCI state mapping pattern.

Each PDSCH transmission occasion is limited to up to two transmission layers for above transmission schemes targeting at reliability improvement and indicated DMRS port(s) are expected to within one CDM group. The redundancy version for PDSCH transmission occasions associated with the second TCI state is shifted with respect to the value of rvₛ by sequenceOffsetforRV-r16 if applicable.

Additionally, default beam assumptions for FR2 are specified for receiving PDSCH, CSI-RS and PDCCH/PDSCH overlapping in case of single-DCI and multi-DCI based multi-TRP/panel transmission.

With reference to procedures according to Rel-16 NR, for single-DCI-based NCJT transmission, up to 8 transmission layers, each TCI code point can correspond to one or two TCI states (so as to 2-port PTRS if applicable) activated by MAC-CE. When 2 TCI states are indicated by DCI, the first TCI state corresponds to the CDM group of the first antenna port indicated by the antenna port indication table, e.g., the first TRP, and the second TCI state corresponds to the other CDM group, e.g., the second TRP. Additional new DMRS entries {0, 2, 3} with two CDM groups without data is supported to improve the flexibility of NCJT based scheduling.

For example, the UE may be provided with a higher layer parameter simultaneousTCI-UpdateList1 or simultaneousTCI-UpdateList2 based on RRC signaling IEs such as CellGroupConfig and/or based on an RRC message such as RRCReconfiguration. The higher layer parameter simultaneousTCI-UpdateList1 or simultaneousTCI-UpdateList2 may then provide to the UE a list of serving cells which can be updated simultaneously for TCI relation with a MAC CE. For example, the simultaneousTCI-UpdateList1 and simultaneousTCI-UpdateList2 may not contain same serving cells. For example, the UE may not expect that the network configures serving cells that are configured with a BWP with two different values for the CORESETPoolIndex in these lists.

For example, the network may activate and deactivate the configured TCI states for a PDSCH of a serving cell or a set of serving cells configured in simultaneousTCI-UpdateList1 or simultaneousTCI-UpdateList2 by sending a TCI states activation/deactivation for UE-specific PDSCH MAC CE. The network may activate and deactivate the configured TCI states for a codepoint of the DCI transmission configuration indication field for PDSCH of a serving cell by sending the enhanced TCI states activation/deactivation for UE-specific PDSCH MAC CE. The configured TCI states for PDSCH may be initially deactivated upon configuration and after a handover. For example, the network may indicate a TCI state for PDCCH reception for a CORESET of a serving cell or a set of serving cells configured in simultaneousTCI-UpdateList1 or simultaneousTCI-UpdateList2 by sending the TCI State Indication for UE-specific PDCCH MAC CE.

For example, a UE may receive an activation command based on a MAC CE that maps at least one codepoint of a DCI field “transmission configuration indication” two TCI states, e.g., one TCI state for TRP A and one for TRP B, respectively. For example, a UE determines an antenna port(s) mapping of a PDSCH reception when one or when two TCI states are indicated in a codepoint of the DCI TCI field as specified in 3GPP standard specification. For example, when a UE is provided by simultaneousTCI-UpdateList1 or simultaneousTCI-UpdateList2 up to two lists of cells for simultaneous TCI state activation, the UE can apply the antenna port QCL provided by parameter TCI-States with same activated tci-StateID value to CORESETs with index p in all configured DL BWPs of all configured cells in a list determined from a serving cell index provided by a MAC CE command.

For example, when a UE is configured by higher layer parameter repetitionScheme set to one of “fdmSchemeA,” “fdmSchemeB,” “tdmSchemeA,” or when the UE is configured by higher layer parameter repetitionNumber in parameter PDSCH-TimeDomainResourceAllocation, if the UE is indicated with two TCI states in a codepoint of the DCI field “transmission configuration indication” and DM-RS port(s) within one CDM group in the DCI field “antenna port(s),” the UE then further determines PDSCH receptions as specified in 3GPP standard specification.

Using Rel-17 NR, there are two different operation modes for multi-TRP PDCCH: PDCCH repetition and SFN based PDCCH transmission. In both modes, the UE can receive two PDCCH transmissions, one from each TRP, carrying the same DCI. In PDCCH repetition mode, the UE can receive the two PDCCH transmissions carrying the same DCI from two linked search space sets each associated with a different CORESET. In SFN based PDCCH transmission mode, the UE can receive the two PDCCH transmissions carrying the same DCI from a single search space set/CORESET using different TCI states.

For multi-TRP PUSCH repetition, according to indications in a single DCI or in a semi-static configured grant provided over RRC, the UE performs PUSCH transmission of the same contents toward two TRPs with corresponding beam directions associated with different spatial relations. For multi-TRP PUCCH repetition, the UE performs PUCCH transmission of the same contents toward two TRPs with corresponding beam directions associated with different spatial relations. For inter-cell multi-TRP operation, for multi-DCI PDSCH transmission, one or more TCI states can be associated with SSB with a PCI different from the serving cell PCI. The activated TCI states can be associated with at most one PCI different from the serving cell PCI at a time.

With reference to procedures according to Rel-17 NR, PDCCH repetition is defined by explicit linkage between two search space sets. The two linked search space sets can be associated with corresponding CORESETs with different TCI states, hence, achieving beam-diversity for PDCCH transmission. In Rel-17 NR, only intra-slot PDCCH repetition is supported, and also, PDCCH repetition is only supported for USS or Type3 CSS. In addition, the linkage is specified at the PDCCH candidate level by restricting configurations of two linked search space sets resulting in one-to-one mapping between monitoring occasions and between PDCCH candidates of the two linked search space sets. Two linked PDCCH candidates have the same aggregation level, same coded bits, and the same DCI payload. To avoid ambiguity at the UE, a reference PDCCH candidate is defined for various procedures such as timelines, PUCCH resource determination, PDSCH reception with mapping Type B or mapping Type A, determination of QCL assumption for PDSCH when TCI field is not present in DCI, etc.

A UE can report whether the UE requires to perform two decoding operations or three decoding operations for a DCI format provided by the two linked PDCCH candidates. In the case of three decoding operations, overbooking for PDCCH receptions/DCI decoding is enhanced accordingly. Furthermore, determination of two QCL-TypeD is specified for FR2 to support time-overlapping PDCCH repetitions. PDCCH repetition is supported also for cross-carrier scheduling through linking two search space sets in both scheduling cell and scheduled cell.

For support of a multi-TRP PUCCH repetition, up to two sets of power control parameters in FR1 or up to two PUCCH-SpatialRelationInfo in FR2 can be activated per PUCCH resource or per PUCCH resource group via MAC-CE. In addition, the multi-TRP PUCCH repetition can be configured by intra-slot PUCCH repetition as well as inter-slot PUCCH repetition for all PUCCH formats. Based on the number of activated PUCCH-SpatialRelationInfo or set of power control parameters for the scheduled PUCCH resource, dynamic switching based on DCI between single-TRP PUCCH repetition and multi-TRP PUCCH repetition can be supported. Separate power control for multi-TRP PUCCH repetition is supported by two activated PUCCH-SpatialRelationInfo or two activated sets of power control parameters. Furthermore, up to two TPC fields in a DCI can be supported for a PUCCH transmission and each TPC field is applied for each corresponding index for closed loop power control state.

For support of a multi-TRP PUSCH repetition, up to two SRS resource sets with usage set to “codebook” or “nonCodebook” can be supported. If a UE is provided two SRS resource sets with usage set to “codebook” or “nonCodebook,” the second SRI field, second TPMI field (if CB-based PUSCH is supported), and second PTRS-DMRS association field are indicated by DCI format 0_1 or 0_2 for PUSCH transmission occasions toward the TRP that is related to the second SRS resource set with usage set to “codebook” or “nonCodebook” for PUSCH transmission scheduled by DCI. In addition, a DCI field defined as “SRS resource set indicator” with 2 bits supports switching between single-TRP PUSCH repetition (corresponding to codepoint “00” and “01”) and multi-TRP PUSCH repetition (corresponding to codepoint “10” and “11”). Separate power control for multi-TRP PUSCH repetitions is supported by linking two SRI fields with two sets of power control parameters via higher layers. Up to two TPC fields for a PUSCH transmission can be supported and each TPC field is applied for a corresponding index of a closed loop power control state. Multi-TRP PUSCH repetitions are also supported for configured grant type 1 and 2.

A multi-TRP PDSCH reception is extended to inter-cell operation in Rel-17 NR. A UE can be configured with an SSB associated with a PCI that is different from the serving cell PCI and is known as additional PCI. At most 7 different additional PCIs can be configured to the UE and only one is activated at a given time for inter-cell multi-TRP operation. The additional PCI can be associated with one or more TCI states, and a gNB can schedule PDSCH from either TRP by indicating a TCI state via a field in DCI.

In order to support an HST-SFN operation, Rel-17 NR provides two approaches for frequency offset compensation: (a) UE-based and (b) TRP-based. For UE-based compensation (scheme A), the UE receives additional reference signals, such as TRS, from the TRPs in a non-SFN manner to facilitate more accurate frequency offset compensation. The corresponding non-SFN TRS configurations are provided to the UE by using two TCI states containing references to the TRS of two TRPs using DCI and MAC signalling. The TRP-based compensation (scheme B) relies on frequency offset pre-compensation at the network side, where each TRP estimates the downlink frequency by using an UL signal, e.g., SRS, and compensates the DL frequency per TRP prior to transmission. For TRP based pre-compensation, a UE also receives two TRS transmitted by the TRPs in a non-SFN manner using two TCI states. However, since network pre-compensates the PDCCH and PDSCH by the difference of the frequency offsets observed between two TRPs, frequency offset tracking at the UE is performed using only one TRS transmitted by a reference TRP.

In the present disclosure, various embodiments of the disclosure may be also implemented in any type of UE including, for example, UEs with the same, similar, or more capabilities compared to legacy 5G NR UEs. Although various embodiments of the disclosure discuss 3GPP 5G NR communication systems, the embodiments may apply in general to UEs operating with other RATs and/or standards, such as next releases/generations of 3GPP, IEEE Wi-Fi, and so on.

The term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the present disclosure, unless otherwise explicitly noted, providing a parameter value by higher layers includes providing the parameter value by a system information block (SIB), such as a SIB1, or by a common RRC signaling, or by UE-specific RRC signaling.

In the present disclosure, the suffix “-rxx” is used to denote a parameter that does not currently exist in specifications and can be introduced to support the disclosed functionalities, with “xx” denoting a number of a 3GPP release for the introduction of the parameter, e.g., xx=19 for Rel-19, or xx=20 for Rel-20, etc.

In the present disclosure, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types “D,” “U” or “F” using at least one time-domain pattern with configurable periodicity.

In the present disclosure, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in 3GPP standard specification.

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for QCL properties.

When considering UE procedures for receiving control information, UE procedures for monitoring PDCCHs and UE procedures for determining a slot format in an FD system with transmissions to and/or receptions from a UE based on multiple TRPs, several issues related to limitations and drawbacks of existing technology need to be overcome.

A first issue relates to different received SINR conditions between non-SBFD slots/symbols and SBFD slots/symbols, respectively, or between different SBFD subbands.

It needs to be considered that for transmissions by a gNB or TRP in a full-duplex system, a different number of transmitter/receiver antennas, a different effective transmitter antenna aperture area, and/or different transmitter antenna directivity settings may be available for gNB or TRP transmissions in a DL slot or symbol, i.e., non-SBFD slot or symbol, when compared to gNB or TRP transmissions in a SBFD slot or symbol. Similar considerations may apply to gNB or TRP receptions in a normal UL slot or symbol when compared to gNB or TRP receptions in the UL sub-band of a SBFD slot. The EPRE settings for gNB or TRP transmissions in a SBFD slot or symbol with full-duplex operation may be constrained to prevent gNB-side or TRP-side receiver AGC blocking and to enable effective implementation of serial interference cancellation (SIC) during gNB or TRP receptions in the UL subband of the SBFD slot or symbol when comparted to the EPRE settings of gNB or TRP transmissions in the normal DL slot.

Therefore, the gNB or TRP transmission power budget and, correspondingly, the received signal strength available for the UE receiver, may not be same for a signal/channel being transmitted by the gNB or TRP on a non-SBFD slot/symbol when compared to transmission by the gNB or TRP of a same signal/channel on an SBFD slot/symbol. Similar observations hold when full-duplex transmission and reception by a gNB based on multiple antenna panels or across TRPs is implemented. QCL and transmit timing aspects may vary between different panels or TRPs. The transmissions or receptions from/by the gNB may be subjected to different link gains depending on the antenna panel used for a transmission or reception instance. Transmissions to or receptions from a same UE using different TRPs may be subjected to different link gains depending on the TRP for a transmission or reception instance.

Similar observations hold for transmissions or receptions using different SBFD subbands where different link conditions may result with respect to a same UE scheduled from the gNB or across TRPs. For example, the available gNB or TRP DL Tx power budget may be more restricted in an SBFD subband when compared to another SBFD subband of the gNB or TRP. For example, a transmission/reception configuration or an SBFD antenna configuration or an EPRE limitations arising from the frequency-domain placement of the SBFD subband in the NR carrier bandwidth to ensure sufficient adjacent channel protection may be different for different TRPs.

Furthermore, interference levels experienced by the UE receiver may differ between receptions in a normal DL slot or symbol and receptions in a SBFD slot or symbol. During receptions in a normal DL slot, the UE receiver may be interfered by co-channel transmissions from neighbor gNBs or TRPs. During receptions in an SBFD slot or symbol, the UE receiver may be subjected to UE-to-UE inter-subband co-channel and/or UE-to-UE adjacent channel cross-link interference (CLI) stemming from UL-to-DL transmissions in the SBFD slot or symbol. Therefore, the resulting interference power levels and their variation experienced by the UE receiver may not be same for reception of signals/channels on non-SBFD slot/symbol when compared to reception of signals/channels on an SBFD slot/symbol.

Similar observations hold for transmissions or receptions using different SBFD subbands where different interference levels may result with respect to a same UE scheduled from the gNB or across TRPs. For example, adjacent channel interference may affect a first SBFD DL subband in the upper part of the NR channel bandwidth more than a second SBFD DL subband in the lower part of the NR channel bandwidth. In another example, UE-to-UE inter-subband co-channel interference may not be symmetrical with respect to the UE actual transmission bandwidth of the aggressor UE, i.e., depend on the active UL BWP, the PUSCH transmission bandwidth allocation and UE Tx filtering. In presence of intra-cell or inter-cell TRP operation, larger variations may be expected due to non-co-location of the TRPs.

Therefore, it is beneficial for a gNB to separately control or adjust receptions by the UE of DL control channels or signals, e.g., PDCCH, in a full-duplex system with respect to transmissions and/or receptions based on multiple TRPs for different non-SBFD and SBFD slot or symbol types and for different SBFD subband types. There is a need to provide procedures for supporting separate control and adjustment of PDCCH receptions by the UE with respect to TRP A, or TRP B, or both TRP A and TRP B, for non-SBFD slots/symbols and SBFD slots/symbols or for different SBFD subbands on an SBFD slot/symbol.

A second issue relates to inter-operability constraints for supporting SBFD operation in an FD system with transmissions to and/or receptions from a UE based on multiple TRPs.

It needs to be considered that SBFD operation may not be deployed or supported by all gNBs or TRPs in an operator's TDD network. It can be expected that the availability and actual use of the SBFD feature during system operation in a deployment and the SBFD configuration in a cell may depend on a number of factors such as benefits, operational constraints and KPIs. Some gNBs or TRPs in the deployment grid may support SBFD but other gNBs or TRPs may not. For example, gNBs in one network segment from a first network vendor may support SBFD but gNBs in another network segment from a second network vendor may not.

In another example, gNBs or TRPs on lower frequency layers of the operator's TDD network may not support SBFD operation while gNBs or TRPs of the same operator on higher frequency layers may support SBFD operation. Some but not all gNBs or TRPs of a same vendor in a network segment may implement and support SBFD operation but it may not be assumed that these gNBs or TRPs use a same SBFD configuration in time and/or frequency domains. For example, gNBs or TRPs deployed for urban macro layer coverage by the operator may support SBFD operation using “DUD” but gNBs or TRPs of the same operator deployed for indoor coverage or industrial service may use a different SBFD configurations such as “DU,” or none at all.

A different size and location of the frequency-domain allocation for the SBFD UL subband may be configured for different gNBs or TRPs due to different available NR carrier bandwidths on the NR channels. gNBs on different frequency layers, i.e., on different NR bands, of a same operator may not operate synchronously with respect to SFN. While gNB phase synchronization and alignment of gNB transmission timing is required for TDD operation on a same NR channel and in a same NR band, gNB timing alignment for dual-connectivity including EN-DC or NR-NR DC is not always possible to achieve due to practical site and deployment constraints. TRPs deployed for intra-cell or inter-cell operation by the operator may not always allow for both DL transmissions and UL receptions to/from a UE, e.g., a TRP may be used for DL-only transmissions to a UE or for UL-only receptions from a UE. The SBFD feature may or may not be available on a TRP due to antenna dimensioning, antenna integration and civil engineering constraints. Some TRPs may need to configure and use a separate SBFD configuration when compared to another TRP on a same cell.

For example, when the SBFD feature is available on a first and on a second TRP in a cell or across cells, SBFD operation may be used on the first TRP but not on the second TRP due to a high resource utilization ratio or a high CLI level observed with respect to the SBFD operation on the second TRP until network conditions or network KPIs change.

Therefore, for a UE operation across TRP A with and TRP B without SBFD support, or across TRP A and TRP B both with SBFD support on a frequency layer, it is beneficial to support different SBFD configurations to the UE for ease of deployment and inter-operability. There is a need to provide solutions and procedures to separately control or adjust receptions by the UE of DL control channels or signals, e.g., PDCCH, for a UE in a full-duplex system with respect to separately or jointly configured and/or indicated SBFD configurations for TRP A and/or for TRP B.

In the present disclosure, following embodiments are provided. In one embodiment, a TCI state and an SBFD configuration of TRP are linked. In one embodiment, an SBFD configuration is determined by UE based on the configured/indicated TCI state. In one embodiment, a set of TCI states is determined by YE based on the provided/indicated SBFD configuration. In one embodiment, an SBFD configuration is restricted when UE is configured for mTRP operation.

In some embodiments, a UE may be provided with an SBFD configuration based on a parameter sbfd-config to determine receptions and/or transmissions on a serving cell supporting full-duplex operation. For example, the UE may be provided with a set of RBs or a set of symbols for an SBFD UL or DL subband on a symbol or in a slot based on sbfd-config. For example, the UE may be provided with a set of symbols or slots for an SBFD subband based on sbfd-config. An SBFD configuration may be provided by higher layers, e.g., RRC, or may be indicated based on DCI and/or MAC-CE signaling. A combination of SBFD configuration based on higher layer parameters such as sbfd-config and indication through DCI and/or MAC-CE signaling may also be used. The UE may determine an SBFD configuration for a symbol or a slot or a set of symbols or a set of slots using higher layer parameters provided for an SBFD configuration and based on reception or transmission conditions such as a slot type “D,” “U,” or “F.”

In one example, the SBFD configuration and/or parameters associated with the SBFD configuration are same for all TRPs. In one example, the SBFD configuration and/or parameters associated with the SBFD configuration can be TRP specific following the aforementioned configuration examples.

For example, an SBFD configuration may provide a set of time-domain resources, e.g., symbols/slots, where receptions or transmissions by the UE are allowed, possible, or disallowed. An SBFD configuration may provide a range or a set of frequency-domain resources, e.g., serving cell, BWP, start and/or end or a set of RBs, where receptions or transmissions by the UE are allowed, possible, or disallowed. An SBFD configuration may provide one or multiple guard intervals or guard RBs for time and/or frequency domain radio resources during receptions or transmissions by the UE, e.g., guard SCs or RBs, guard symbols. An SBFD configuration may be provided based on one or multiple resource types such as “non-SBFD symbol” or “SBFD symbol,” or “simultaneous Tx-Rx,” “Rx only,” “Tx only” or “D,” “U,” “F,” “N/A.”

An SBFD configuration may be associated with one or multiple scheduling behaviors, e.g., for “dynamic grant,” for “configured grant,” for “any.” An SBFD configuration and/or parameters associated an SBFD configuration may include indications or values to determine Tx power settings of receptions by the UE, such as, reference power, energy per resource element (EPRE), or power offset of a designated channel/or signal type transmitted by a serving gNB, or to determine the power and/or spatial settings for transmissions by the UE.

For example, a UE may be provided with an SBFD configuration to determine receptions and/or transmissions on a serving cell supporting full-duplex operation. For example, the UE may be provided with a set of RBs or a set of symbols for an SBFD UL or DL subband on a symbol or in a slot (frequency domain resources). For example, the UE may be provided with a set of symbols or slots for an SBFD subband (time domain resources). In one example, the SBFD configuration applies to all TRPs in the cell.

In one example, the SBFD configurations are separately provided for each TRP in the cell. In one example, a common SBFD configuration is provided for a cell and an additional delta configuration is separately provided for each TRP in the cell, wherein the delta configuration can include additional frequency/time domain resources to be added to the common configuration and/or excluded frequency/time domain resources to be excluded from the common configuration.

In one example, the SBFD configurations are separately provided for each TRP in the cell. In one example, a common SBFD configuration is provided for a first TRP of the cell and an additional delta configuration is provided for each other TRP in the cell, wherein the delta configuration can include additional frequency/time domain resources to be added to the common configuration and/or excluded frequency/time domain resources to be excluded from the common configuration.

For example, an SBFD configuration and/or parameters associated with SBFD configuration based on sbfd-config may be provided by higher layer, e.g., RRC, or may be indicated based on DCI and/or MAC-CE signaling. A combination of SBFD configuration and/or parameterization based on higher layer parameters and indication through DCI and/or MAC-CE signaling may be used. The UE may determine an SBFD configuration for a symbol or a slot or a set of symbols or a set of slots using higher layer parameters provided for an SBFD configuration and based on reception or transmission conditions such as for a slot or symbol type “D,” “U,” or “F” or a slot or a symbol type “SBFD” or “non-SBFD” or for an SBFD subband type such as “SBFD DL subband,” “SBFD UL subband,” or “SBFD Flexible subband.”

For example, an SBFD configuration may provide a set of time-domain resources, e.g., symbols/slots, where receptions or transmissions by the UE are allowed, possible, or disallowed. In one example, the time-domain resources are same (e.g., common) for all TRPs as aforementioned. In another example, the time-domain resources can be different for each TRP, as aforementioned. An SBFD configuration may provide a range or a set of frequency-domain resources, e.g., serving cell, BWP, start and/or end or a set of RBs, where receptions or transmissions by the UE are allowed, possible, or disallowed. In one example, the frequency-domain resources are same (e.g., common) to all TRPs as aforementioned.

In another example, the frequency-domain resources can be different for each TRP, as aforementioned. An SBFD configuration may provide one or multiple guard intervals or guard RBs for time and/or frequency domain radio resources during receptions or transmissions by the UE, e.g., guard SCs or RBs, guard symbols, wherein the provided SBFD configuration may be same or different for each TRP as aforementioned. An SBFD configuration may be provided based on one or multiple resource types such as “non-SBFD symbol” or “SBFD symbol,” or “simultaneous Tx-Rx,” “Rx only,” “Tx only” or “D,” “U,” “F,” “N/A.” In one example, SBFD configuration is performed at a slot level.

In one example, SBFD configuration is performed at a symbol level. In one example, SBFD configuration is performed at a slot level and symbol level. In one example, An SBFD configuration may be associated with one or multiple scheduling behaviors, e.g., for “dynamic grant,” for “configured grant,” for “any.” An SBFD configuration and/or parameters associated with an SBFD configuration may include indications or values to determine Tx power settings of receptions by the UE, such as, reference power, EPRE, or power offset of a designated channel/or signal type transmitted by a serving gNB; to determine the power and/or spatial settings for transmissions by the UE.

For example, an SBFD configuration and/or parameters associated with the SBFD configuration may be provided to the UE by means of common RRC signaling using SIB, or be provided by UE-dedicated RRC signaling such as ServingCellConfig. For example, an SBFD configuration and/or parameters associated with the SBFD configuration may be provided to the UE using an RRC-configured TDRA table, or a PDCCH, PDSCH, PUCCH or PUSCH configuration, and/or DCI-based signaling that can indicate to the UE a configuration or allow the UE to determine an SBFD configuration on a symbol or slot.

For example, the UE may be provided with information for an SBFD subband configuration such as an SBFD UL subband in one or more SBFD symbols by higher layer signaling. For example, a frequency-domain location and a size or a frequency-domain occupancy of the SBFD subband may be provided to the UE by means of indicating or assigning a start RB and an allocation bandwidth, or based on a resource indicator value (RIV), or a number of RBs, or a bitmap. An SBFD subband configuration may be provided to the UE with respect to a common resource block (CRB) grid. An SBFD subband configuration may be provided to the UE with respect to a UE BWP configuration, e.g., excluding RBs in an NR carrier BW that are not within a configured or an active UE BWP.

An SBFD subband configuration may be provided based on a reference RB and/or based on a reference SCS. The UE may be provided with information for an SBFD subband configuration such as an SBFD DL subband in an SBFD slot or symbol by higher layer signaling. For example, a frequency-domain location and a size or a frequency-domain occupancy of an SBFD DL subband may be provided to the UE by means of indicating or assigning a start RB and an allocation bandwidth, or an RIV value, or a number of RBs, or a bitmap, separately from a configuration provided to the UE for an SBFD UL subband. An SBFD DL subband configuration may be provided to the UE with respect to a CRB grid, or with respect to a UE BWP configuration.

An SBFD DL subband configuration may be provided based on an indicated reference RB and/or based on a reference SCS. There may be multiple SBFD DL subband configurations in an SBFD symbol or slot. If multiple SBFD DL subband configurations are provided for an SBFD symbol or slot, the SBFD DL subbands may be non-contiguous. For example, two SBFD DL subband configurations may be provided to the UE for an SBFD symbol by higher layers. A same SBFD DL subband configuration or a same SBFD UL subband configuration may be provided for multiple symbols or slots, or different symbols or slots may be indicated or assigned separate SBFD DL subband and/or SBFD UL subband configurations, respectively.

For example, an SBFD configuration and/or parameters associated with the SBFD configuration for sbfd-config may be provided to the UE using tdd-UL-DL-ConfigurationCommon as example for RRC common configuration and/or tdd-UL-DL-ConfigurationDedicated as example for UE-specific configuration. The UE may determine an SBFD configuration based on a common TDD UL-DL frame configuration of a serving cell by receiving a SIB such as a SIB1 when accessing the cell from RRC_IDLE/INACTIVE or by RRC signaling when the UE is configured with an SCell or additional SCGs by an IE ServingCellConfigCommon in RRC_CONNECTED. The UE may determine an SBFD configuration based on a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration can designate a slot or symbol as one of types “D,” “U” or “F” using at least one time-domain pattern with configurable periodicity.

In some embodiments, a TCI state may be used for beam indication. A TCI state may refer to a DL TCI state for DL channels, e.g., PDCCH or PDSCH, an UL TCI state for UL channels, e.g., PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be gNB or UE panel specific or common across panels. In some examples, an UL TCI state may be replaced by an SRS resource indicator (SRI).

In some embodiments, a cell may include or includes more than one TRP. For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) CSI-RS resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on.

In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples.

In one example, a TRP may be identified by a group (e.g., one or more) SRS resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

In the present disclosure, for brevity of description, mTRP operation for a TRP A and a TRP B associated with a configuration and/or an indication of a CORESETPoolIndex of a first and/or a second value, respectively, or mTRP operation for a TRP A and a TRP B associated with a configuration and/or an indication of two simultaneous TCI states to the UE may be used in certain examples. For example, the UE may receive a PDCCH from TRP A using a CORESET with CORESETPoolIndex equal to the first value, e.g., zero, and receive a PDCCH from TRP B using a CORESET with CORESETPoolIndex equal to the second value, e.g., one. For example, the UE may be indicated two TCI states in a codepoint of the DCI field “transmission configuration indication” wherein the first TCI state corresponds to receptions from TRP A, and the second TCI state corresponds to receptions from TRP B. While these may be used as examples, an association of TRP A and TRP B, respectively, with SSBs or CSI-RS resources and/or simultaneous update of spatial relations may be considered equivalent. Terminology such as “two TCI states,” and other terms is used for illustrative purposes and is therefore not normative. Other terms that refer to same functions can also be used.

In some embodiments, transmissions and/or receptions associated with more than one TRP may involve more than one cell wherein a cell is associated with a cell identifier such as a physical cell ID (PCI). For example, mTRP operation may be referred to as inter-cell mTRP operation. For example, a TRP may be identified by a CORESETPOOLIndex, by a group or set (e.g., one or more) of SSBs, by a group or set (e.g., one or more) of CSI-RS resources or resource sets, by a group or set (e.g., one or more) of SRS resources or resource sets, or by a group or set (e.g., one or more) of TCI states such as exemplified for intra-cell mTRP. For example, a UE may be configured with an SSB associated with a PCI which is different from the serving cell PCI, known as additional PCI. For example, an additional PCI can be associated with one or more TCI states, and a gNB can schedule a DL or UL channel or signal from either TRP by indicating a corresponding TCI state via a TCI field in DCI.

In some embodiments, a different number of TRXs, a different effective transmitter antenna aperture area, and/or different transmitter antenna directivity settings may be available for transmissions from TRP A to a UE in a slot or symbol, when compared to TRP B transmissions in a slot or symbol, and/or a different number of TRXs, a different effective reception antenna aperture area, and/or different reception antenna directivity settings may be available for receptions by the TRP A of transmissions from a UE in a slot or symbol, when compared to TRP B receptions in a slot or symbol. For example, transmissions to and receptions from a UE by a TRP A and a TRP B, respectively, may correspond to the use of a first and a second antenna panel on a deployment site, e.g., for gNB side SBFD operation supported based on an SBFD antenna configuration such as SBFD configuration option 2 in 3GPP standard specification.

For conciseness of the descriptions and for illustration purposes, the following example mTRP cases with respect to the provided, e.g., configured and/or indicated SBFD configurations to the UE may be considered in the disclosure. Same or different SBFD configurations provided to the UE for transmissions/receptions to/from TRP A and TRP, respectively, may apply on a symbol, a slot, or a duration.

In one example, TRP A and TRP B support the SBFD feature and are provided with a same SBFD configuration.

In another example, TRP A and TRP B support the SBFD feature and are provided with different SBFD configurations.

In one example, TRPA A and TRP B are provided with a same frequency-domain SBFD configuration and are provided with different SBFD time-domain configurations.

In one example, TRPA A and TRP B are provided with different frequency-domain SBFD configurations and are provided with a same SBFD time-domain configuration.

In one example, TRPA A and TRP B are provided with different frequency-domain SBFD configurations and are provided with different SBFD time-domain configurations.

In one example, TRP A supports the SBFD feature and TRP B does not support the SBFD feature, e.g., corresponding to mTRP-SBFD where no SBFD configuration is provided for TRP B.

For example, when a same time- and frequency-domain SBFD configuration of a TRP A and a TRP B is provided to the UE by higher layers, e.g., in described embodiments and/or examples in the present disclosure, for a duration, including the case where the duration is not explicitly limited, e.g., such as until reception by the UE of another higher layer parameter re-configuring parts or all of the SBFD configuration for TRP A and/or TRP B or such as until a higher layer configuration is released, the UE may be provided with different time- and/or frequency-domain SBFD configurations, respectively, at a later instant, e.g., in described embodiments and/or examples in the present disclosure, for TRP A and TRP B.

For example, when a same time- and frequency-domain SBFD configuration of a TRP A and a TRP B is provided to the UE by higher layers, e.g., in described embodiments and/or examples in the present disclosure, and DCI-based or MAC-CE signaling to the UE indicates another usage of the transmission/reception direction for a higher layer provided SBFD configuration on a symbol/slot or for an SBFD subband, different time- and frequency-domain SBFD configuration on a symbol or slot of TRP A and TRP B respectively, can apply, e.g., in described embodiments and/or examples in the present disclosure.

For example, when different time-domain and/or frequency-domain SBFD configurations of a TRP A and a TRP B are provided to the UE by higher layers, e.g., in described embodiments and/or examples in the present disclosure, but DCI-based or MAC-CE signaling to the UE indicates another usage of the transmission/reception direction for a higher layer provided SBFD configuration on a symbol/slot or for an SBFD subband, a same time-domain and/or frequency-domain SBFD configuration on a symbol or slot of TRP A and TRP B respectively, can apply, e.g., in described embodiments and/or examples in the present disclosure.

For example, when a same or different time-domain and/or frequency-domain SBFD configurations of a TRP A and a TRP B are provided to the UE by higher layers, e.g., in described embodiments and/or examples in the present disclosure, but a DCI-based or a MAC-CE signaling to the UE indicates another usage of the transmission/reception direction for a higher layer provided SBFD configuration on a symbol/slot or for an SBFD subband, no SBFD configuration may be available, e.g., in described embodiments and/or examples in the present disclosure.

In one embodiment, a UE is provided with a first SBFD configuration for TRP A and with a second SBFD configuration for TRP B, respectively. The UE is provided with a first set of TCI states for TRP A and with a second set of TCI states for TRP B, respectively. The first SBFD configuration and the first set of TCI states (of TRP A) are associated with each other. The second SBFD configuration and the second set of TCI states of TRP B are associated with each other.

In one example, when a UE receives a DL signal or channel such as an SSB, a CSI-RS, a PTRS, a PDCCH or a PDSCH from TRP A on a symbol based on a TCI state from the first set of TCI states, the UE can assume receptions from TRP A on the symbol according to the associated first SBFD configuration. When a UE receives a DL signal or channel such as an SSB, a CSI-RS, a PTRS, a PDCCH or a PDSCH from TRP B on a symbol based on a TCI state from the second set of TCI states, the UE can assume receptions from TRP B on the symbol according to the associated second SBFD configuration. For example, the UE receives a DCI with a “transmission configuration indication” field, determines a TCI state based on a codepoint of the DCI with a TCI field wherein a codepoint may be associated with one or two TCI states, and the UE further determines an associated SBFD configuration based on the TCI state.

In another example, when a UE receives a DL signal or channel such as an SSB, a CSI-RS, a PTRS, a PDCCH or a PDSCH from TRP A on a symbol based on the first SBFD configuration, the UE can assume receptions from TRP A on the symbol according to a TCI state from the associated first set of TCI states. When a UE receives a DL signal or channel such as an SSB, a CSI-RS, a PTRS, a PDCCH or a PDSCH from TRP A on a symbol based on the second SBFD configuration, the UE can assume receptions from TRP A on the symbol according to a TCI state from the associated second set of TCI states. For example, the UE is provided or indicated an SBFD configuration for a symbol or slot. The UE receives a DCI with a “transmission configuration indication” field. The UE determines the set of TCI states which are associated with the SBFD configuration.

For example, when the first SBFD configuration is provided or indicated to the UE for a symbol or slot, the UE selects the first set of TCI states for receptions on the symbol or slot. For example, when the second SBFD configuration is provided or indicated to the UE for a symbol or slot, the UE selects the second set of TCI states for receptions on the symbol or slot. A codepoint of the DCI with a TCI field may be associated with one or two TCI states. The UE determines a TCI state from the selected set of TCI states based on the first or the second SBFD configuration.

In one embodiment, the UE determines an SBFD configuration of a TRP for receptions from and transmissions to the TRP based on a configured and/or an indicated TCI state of the TRP, wherein a TCI state is associated with an SBFD configuration.

In one example, the UE is provided with a set of N=16 configured TCI states configured by RRC signaling such as IE PDSCH-Config. Within the set of N configured TCI states, a first subset of N1=4 TCI states is associated with SSB indices 0, 1, 2 and 3 for receptions from TRP A, and a second subset of N2=4 TCI states is associated with SSB indices 4, 5, 6 and 7 for receptions from TRP B. A serving cell index and a QCL type can be configured. The UE is provided by RRC signaling such as RRCReconfiguration with a first SBFD configuration of type “DUD” wherein an SBFD UL subband is configured on 51 center RBs in the NR carrier BW of an SBFD symbol and with a second SBFD configuration of type “none,” e.g., no SBFD configuration is provided or an SBFD configuration is not indicated.

The first and the second SBFD configurations are associated with the first and the second subsets of N1 and N2 TCI states by RRC signaling, respectively. For example, the lists of TCI states from the first and second subsets of N1 and N2 TCI states (or the TCI state IDs) can be indicated to the UE for the first and second SBFD configurations, respectively, as part of an associated resource configuration. The network can activate and deactivate a configured TCI state from the set of N TCI states for a codepoint of the DCI “transmission configuration indication” field for a PDSCH (or PDCCH) of a serving cell by sending the TCI states activation/deactivation for UE-specific PDSCH (or PDCCH) MAC CE. The UE can receive an activation command based on the MAC CE that maps a codepoint of a DCI field “transmission configuration indication” to one or to two TCI states. For example, when a codepoint of the DCI TCI field is associated with two TCI states, one TCI state may be associated with TRP A and one TCI state may be associated with TRP B, respectively.

When the UE receives a DCI format with a TCI field that maps a codepoint to one TCI state, and the UE determines that a change from a current TCI state for PDSCH reception to a new TCI state is indicated by the DCI, the UE further determines the SBFD configuration associated with the new TCI state. For example, if a new TCI state from the first subset of N1 TCI states is indicated, the UE selects the first SBFD configuration of type “DUD.” For example, if a new TCI state from the second subset of N2 TCI states is indicated, the UE selects the second SBFD configuration of type “none.” The UE then assumes PDSCH receptions based on the first or the second SBFD configuration. For example, if the indicated new TCI state is from the first subset of N1 TCI states, the UE may not consider valid a PDSCH resource allocation if the PDSCH frequency-domain allocation comprises RBs in an SBFD UL subband of the first SBFD configuration, or the UE may configure its reception filtering setting based on the known frequency-domain location of the SBFD DL subbands based on the first SBFD configuration.

For example, if the indicated new TCI state is from the second subset of N2 TCI states, the UE may consider valid any PDSCH resource allocation, or the UE may configure its reception filtering setting based on the active UE DL BWP based on the second SBFD configuration. A suitable activation delay and/or a validity duration for an SBFD configuration associated with a TCI state may be used. An activation delay and/or a validity duration of an SBFD configuration may be a same or may be different with respect to a beam activation delay and/or minimum processing requirement when compared to the associated TCI state.

When the UE receives a DCI format with a TCI field that maps a codepoint to two TCI states, e.g., for simultaneous update of the TCI states for TRP A and TRP B, and the UE determines that a change from a current TCI state for PDSCH reception to at least one new TCI state is indicated by the DCI, the UE further determines the SBFD configuration associated with the new TCI state. The UE may then determine that a same or a different SBFD configuration associated with the two TCI states for TRP A and TRP B, respectively, results from the indication of at least one updated TCI state in the DCI. When a different SBFD configuration is associated with the two TCI states for TRP A and TRP B, respectively, a suitable rule such as based on a reference configuration, a priority, a ranking, a list or order, a subset, or a superset based on more than one SBFD configurations and/or SBFD subband type may be used to further determine the UE processing assumptions.

For example, if the UE is indicated a simultaneous TCI state update by a codepoint in the DCI TCI field resulting in a TCI state from the first subset of N1 TCI states for TRP A and in a TCI state from the second subset of N2 TCI states for TRP B associated with the first and the second SBFD configuration, respectively, the UE may determine that DL receptions in the SBFD UL subband of the first SBFD configuration associated with TRP A may then also not occur for PDSCH receptions from TRP B when the first SBFD configuration of type “DUD” is configured as reference configuration or configured with a higher priority than the second SBFD configuration of type “none.”

A motivation for enabling different SBFD configurations associated with different TCI states is support for SBFD for UE operation across TRP A with and TRP B without SBFD support or across TRP A and TRP B with SBFD support but benefiting from separate SBFD configuration for ease of deployment and inter-operability. Another motivation is increased gNB scheduling flexibility for SBFD operation in RRC_CONNECTED mode where cell-common configuration of SBFD resources is not necessary, i.e., reuse of existing TCI state signaling/indication allows the gNB to perform scheduling to/from the UE on a per-need basis without signaling restrictions.

In one example, an SBFD configuration associated with one or more of N TCI states is configured by RRC. Existing MAC CE signaling can include a subset of M (M; N) TCI states or TCI state code points from the set of N TCI states, wherein a code point is signaled in the “transmission configuration indication” field of a DCI used for indication of the TCI state wherein a codepoint can map to one or to two TCI states. A new extended TCI field of length L′>3 bits can be used. Alternatively, an existing first TCI field of length L=3 bits is reused, and a new second TCI field of length L′>0 bits can be used. A motivation is a reduced UE modem design delta and a reduced specification impact when the existing DCI TCI field for indication of TCI states and/or MAC-CE based signaling to (de-)activate TCI states can be reused while allowing the UE to determine the SBFD configuration of a TRP based on existing L1 signaling. Association of an SBFD configuration with a TCI state occurs in higher protocol layers.

In one example, one or more SBFD configuration and N TCI states are configured by RRC. New MAC CE signaling can include a subset of M (M; N) TCI states or TCI state code points from the set of N TCI states and an SBFD configuration associated with a subset of M TCI states or TCI state code points, wherein a code point is signaled in the “transmission configuration indication” field of a DCI used for indication of the TCI state wherein a codepoint can map to one or to two TCI states. An existing TCI field of length L=3 bits can be reused, or a new extended TCI field of length L′>3 bits can be used. Alternatively, an existing first TCI field of length L=3 bits is reused, and a new second TCI field of length L′>0 bits can be used. A motivation is increased signaling flexibility in RRC_CONNECTED mode to signal from a set of one of multiple candidate SBFD configurations with one or multiple TCI states with respect to one TRP or with respect to joint SBFD configurations for TRP A and TRP B.

In one example, a same SBFD configuration is provided to a UE by higher layers with respect to the configured and/or (de-)activated and/or indicated TCI states of a TRP A or a TRP B, respectively. The UE expects to be provided with a same SBFD configuration for the configured or indicated TCI states of a PDCCH or a PDSCH reception from TRP A. The UE expects to be provided with a same SBFD configuration for the configured or indicated TCI states of a PDCCH or a PDSCH reception from TRP B. The SBFD configuration associated with the TCI states of TRP A and the SBFD configuration associated with the TCI states of TRP B can then be same or different. A motivation is simplified UE implementation without restricting the possibility to use and operate separate SBFD configurations across two TRPs.

In one example, a first SBFD configuration associated with one or more of N TCI states configured by RRC is associated with PDCCH receptions from a TRP and a second SBFD configuration associated with one or more of N TCI states configured by RRC is associated with PDSCH receptions from the TRP. The SBFD configuration associated with the TCI states of PDCCH receptions from a TRP and the SBFD configuration associated with the TCI states of PDSCH receptions from the TRP can then be the same or can be different.

In some examples, TCI states for PDCCH receptions from TRP A and TRP B, respectively, can be associated with a first and a second SBFD configuration, respectively, and a third and a fourth SBFD configuration may be associated with PDSCH receptions by the UE from TRP A and TRB B, respectively. For example, the first or the second SBFD configuration associated with PDCCH reception from TRP A and TRP B may be same. A motivation is improved flexibility for beamforming to ensure coverage for PDCCH reception by the UE based on cell-common beams.

In one example, an SBFD configuration associated with one or more of N TCI states is configured by RRC. Existing MAC CE signaling can include a subset of M (M≤N) TCI states or TCI state code points from the set of N TCI states, wherein a code point is signaled in the “transmission configuration indication” field of a DCI used for indication of the TCI state wherein a codepoint can map to one or to two TCI states. An existing TCI field of length L=3 bits is reused. A first SBFD configuration is provided to the UE including a frequency-domain allocation of one or more SBFD subbands on an SBFD symbol/slot and a time-domain allocation for the SBFD symbols wherein, for simplicity and illustration purposes, it is assumed that the same SBFD frequency-domain allocation is applied to the SBFD symbols/slots. The first SBFD configuration also includes a list of TCI states, e.g., using tci-StateID, to associate one or more TCI states with the SBFD configuration.

For example, the first SBFD configuration may include tci-StateID 1, 2, 3 and 4 associated with receptions from TRP A. A second SBFD configuration is provided to the UE including a same or a different frequency- and/or time-domain allocation. For example, the second SBFD configuration may include tci-StateID 5, 6, 7 and 8 associated with receptions from TRP B.

In one example, an SBFD configuration associated with one or more of N TCI states is configured by RRC. Existing MAC CE signaling can include a subset of M (M≤N) TCI states or TCI state code points from the set of N TCI states, wherein a code point is signaled in the “transmission configuration indication” field of a DCI used for indication of the TCI state wherein a codepoint can map to one or to two TCI states. An existing TCI field of length L=3 bits is reused. L=4 SBFD configurations indexed by sbfdConfigurationID 1, 2, 3 and 4, respectively, are provided to the UE wherein the frequency-domain and/or time-domain allocation of the L SBFD configurations may be same or different. The UE is provided with a set of TCI states wherein a TCI state may be indexed by tci-StateID. A TCI state configuration is associated with an SBFD configuration index. For example, the TCI state with tci-StateID 1 is linked with SBFD configuration of sbfdConfigurationID 2, the TCI state with tci-StateID 2 is linked with SBFD configuration of sbfdConfigurationID 3, the TCI state with tci-StateID 3 is linked with SBFD configuration of sbfdConfigurationID 1, etc.

In one example, one or more SBFD configurations and N TCI states are configured by RRC. New MAC CE signaling can include a subset of M (M≤N) TCI states or TCI state code points from the set of N TCI states and an SBFD configuration associated with a subset of M TCI states or TCI state code points, wherein a code point is signaled in the “transmission configuration indication” field of a DCI used for indication of the TCI state wherein a codepoint can map to one or to two TCI states. An existing TCI field of length L=3 bits can be reused. For example, a first subset of M₁=4 TCI states with tci-StateID 1, 2, 3 and 4 is associated with receptions from TRP A and a second subset of M₂=4 TCI states with tci-StateID 5, 6, 7 and 8 is associated with receptions from TRP B. L=4 SBFD configurations indexed by sbfdConfigurationID 1, 2, 3 and 4, respectively, are provided to the UE wherein the frequency-domain and/or time-domain allocation of the L SBFD configurations may be same or different.

In a new TCI state indication for UE-specific PDCCH MAC CE, a TCI State ID field may indicate the TCI state for the identified by tci-StateID in higher layer signaling, applicable to the CORESET identified by the CORESET ID field. For example, a TCI state from the M₁ and/or M₂ TCI states may be indicated. Another MAC CE field can provide an SBFD configuration index field with an SBFD configuration index provided by higher layers. For example, a TCI state index in the TCI State ID field may correspond to an SBFD configuration index in the sequential order in which the fields are mapped. A motivation is that when fewer TCI states such as for PDCCH receptions are supported, the association of the PDCCH TCI state and the associated SBFD configuration can be updated with reduced overhead. In another example, a new extended TCI field of length L′>3 bits can be used or an existing first TCI field of length L=3 bits is reused and a new second TCI field of length L′>0 bits can be used instead of a new MAC CE with a new SBFD configuration index field to provide the associated SBFD configuration indication to the UE for a TCI state.

In one example, an SBFD configuration associated with a configured or an indicated TCI state for receptions by the UE using the TCI state from a starting symbol and/or for a number of symbols is applied by the UE from the same starting symbol and/or for the number of symbols. For example, the UE can receive a TCI state activation command for PDCCH by MAC CE, used to map up to 8 TCI states and/or pairs of TCI states to the codepoints of the DCI field “transmission configuration indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs.

If the activation command maps TCI-State and/or UL-TCI-State to only one TCI codepoint, the UE applies the indicated TCI-State and/or UL-TCI-State to one or to a set of CCs/DL BWPs, and if applicable, to one or to a set of CCs/UL BWPs once the indicated mapping for the one single TCI codepoint is applied as described in 3GPP standard specification. When the UE determines an SBFD configuration associated with an activated TCI state IDs, if a UE is provided higher layer parameter tci-PresentInDCI set as “enabled” for the CORESET scheduling a PDSCH, the UE assumes that the TCI field is present in the DCI format 1_1 of the PDCCH transmitted on the CORESET. If a UE is provided higher layer parameter tci-PresentDCI-1-2 for the CORESET of a PDCCH scheduling the PDSCH, the UE assumes that the TCI field with a size indicated by tci-PresentDCI-1-2 is present in the DCI format 1_2 of the PDCCH. If a UE is provided tci-PresentInDCI set as “enabled” for the CORESET with a PDCCH scheduling a multicast PDSCH, the UE assumes that the TCI field is present in the DCI format 4_2 of the PDCCH. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability in 3GPP standard specification, for determining PDSCH antenna port quasi co-location, the UE assumes that the TCI state or the QCL assumption for the PDSCH is identical to the TCI state or QCL assumption whichever is applied for the CORESET of the PDCCH transmission within the active BWP of the serving cell. The UE then applies the associated SBFD configuration corresponding to the TCI state or the QCL assumption for the PDSCH according to the same processing criteria.

A motivation is simplified UE implementation when the update of an associated SBFD configuration can follow the same processing timeline and/or activation delays and/or criteria applied to the update of a TCI state for DL signal or channel reception.

In one example, an SBFD configuration associated with a configured or an indicated TCI state for receptions by the UE using the TCI state from a starting symbol and/or for a number of symbols is applied by the UE based on a separate starting symbol and/or a separate set of symbols on which the SBFD configuration applies. For example, the UE can receive a TCI state activation command for PDCCH by MAC CE, used to map up to 8 TCI states and/or pairs of TCI states to the codepoints of the DCI field “transmission configuration indication” for one or for a set of CCs/DL BWPs, and if applicable, for one or for a set of CCs/UL BWPs.

When a set of TCI state IDs are activated for a set of CCs/DL BWPs and if applicable, for a set of CCs/UL BWPs, where the applicable list of CCs is determined by the indicated CC in the activation command, the UE may apply the associated SBFD configuration corresponding to the TCI state indicated by the DCI field “transmission configuration indication” with respect to PDCCH reception on a next symbol following the last symbol of the received PDCCH, e.g., separate from the TCI state or the QCL assumption determined by the UE using the indicated TCI state for the PDSCH. A motivation is reduced re-configuration delays and the possible selection of an updated SBFD configuration for TRP A or TRP B with respect to the TDD UL-DL frame configuration in a period p1 and/or p2, e.g., the starting symbol of an associated SBFD configuration can be updated and controlled independently from the TCI state.

In one example, when the UE determines different SBFD configurations on a symbol/slot for transmissions to and/or receptions from TRP A and TRP B, respectively, the UE further determines the transmission direction on the symbol/slot based on a default or a provided reference, a priority, a ranking, or a list of the more than one SBFD configurations. In an alternative example, the UE further determines an applicable SBFD configuration as subset, or as a superset based on the more than one SBFD configurations. For example, the UE may support transmissions to and/or receptions from multiple TRPs based on a same or different SBFD configurations provided for TRP A and TRP B, respectively, by higher layers.

For example, a same SBFD configuration provided by higher layers may apply for transmissions to and/or receptions from TRP A and/or TRP B and the transmission direction of an SBFD symbol or an SBFD subband on an SBFD symbol/slot may be changed based on an indication received by DCI signaling or in a MAC-CE. For example, different SBFD configuration may be provided by higher layers for transmissions to and/or receptions from TRP A and/or TRP B, respectively. Without loss of generality, additional restrictions with respect to provided and/or indicated SBFD configurations on a symbol or slot for TRP A or TRP B, respectively, may apply, e.g., a frequency-domain restriction resulting in one SBFD DL subband per TRP or a SBFD “DU” type restriction on an SBFD symbols with mTRP operation.

On an SBFD symbol/slot where the provided or indicated SBFD configuration on the symbol for TRP A results in a different transmission direction than the provided or indicated SBFD configuration on the symbol for TRP B, the UE determines the transmission direction on the SFBD symbol based on a reference or a default TRP.

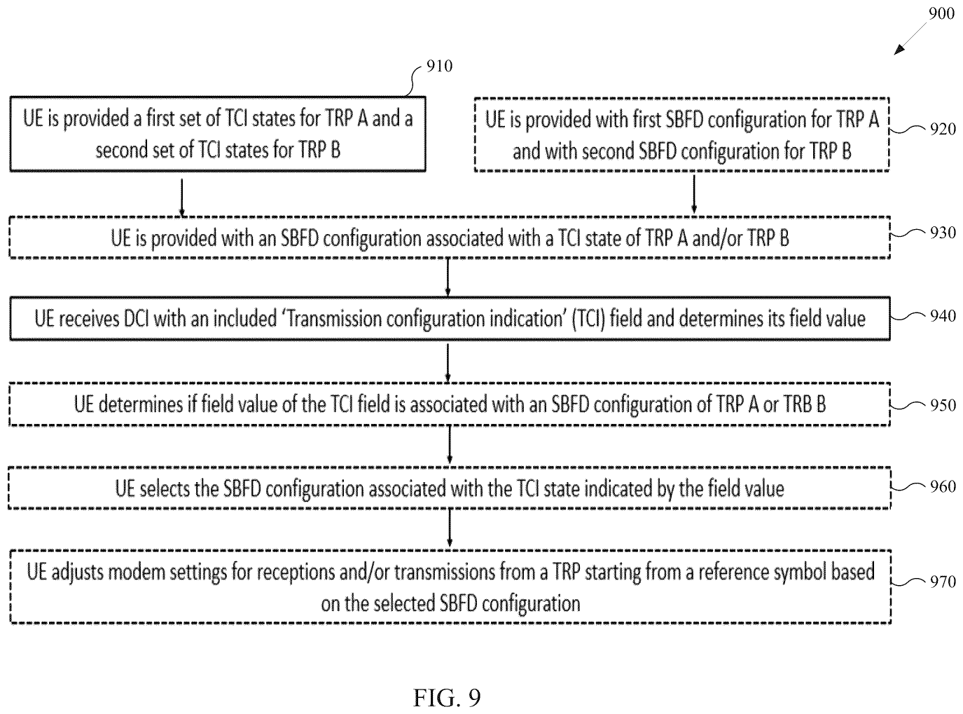

FIG. 9 illustrates a flowchart of UE method 900 for a determination of an SBFD configuration based on a TCI state for mTRP operation in a full-duplex communication according to embodiments of the present disclosure. The UE method 900 as may be performed by a UE (e.g., 111-116 as illustrated in FIG. 1). An embodiment of the UE method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, in step 910, the UE is provided a first set of TCI states. In Step 920, the UE is provided with first SBFD configurations. In step 930, the UE is provided with an SBFD configuration associated with a TCI state of TRP A and/or TRP B. In step 940, the UE receives DCI with an included TCI field and determines its value. In step 950, the UE determines if the field value of TC field is associated with an SBFD configuration. In step 960, the UE selects the SBFD configuration. In step 970, the UE adjusts modem setting reception and/or transmission from TRP starting from a reference symbol based on the selected SBFD configuration.

In one embodiment, the UE selects a set of TCI states and determines a TCI state from the selected set of TCI states for receptions from or transmissions to the TRP based on a provided and/or indicated SBFD configuration, wherein a set of TCI states is associated with an SBFD configuration. In another embodiment, the UE selects a reception or a transmission parameter from a set of reception or transmission parameters based on a provided and/or indicated SBFD configuration wherein a reception parameter may correspond to a parameter for a PDCCH or a PDSCH or a CSI-RS reception, and a transmission parameter may correspond to a parameter for a PUSCH or a PUCCH or an SRS transmission.

In one example, the UE is provided with two sets S1 and S2 of TCI states wherein S1 indicates N1=16 and S2 indicates N2=8 configured TCI states. For example, RRC signaling such as IE PDSCH-Config may be used to configure the two sets of TCI states S1 and S2. For example, the first set S1 with N1=16 TCI states links a TCI state to one of SSB indices 0, 1, 2 and 3 for receptions from TRP A, and the second set S2 with N2=8 TCI states links a TCI state to one of SSB indices 4, 5, 6 and 7 for receptions from TRP B. A serving cell index and a QCL type may be configured for a TCI state in a set of TCI states. The UE is provided by RRC signaling such as RRCReconfiguration with a first SBFD configuration of type “DUD” wherein an SBFD UL subband is configured on 51 center RBs in the NR carrier BW of an SBFD symbol and with a second SBFD configuration of type “none,” e.g., no SBFD configuration is provided or an SBFD configuration is not indicated.

The first and the second SBFD configurations are linked with the first and the second sets of TCI states S1 and S2 by RRC signaling, respectively. For example, an associated set of TCI states for the first or the second SBFD configuration can be indicated to the UE as part of associated resource configuration, respectively. For example, the first SBFD configuration is associated with the first set S1 of TCI states (of TRP A) as resource configuration and the second SBFD configuration is associated with the second set S2 of TCI states (of TRP B) as resource configuration. The network can activate or deactivate a configured set of TCI states or a TCI state from a set of TCI states for a codepoint of the DCI “transmission configuration indication” field for a PDSCH (or PDCCH) of a serving cell by sending the TCI states activation/deactivation for UE-specific PDSCH (or PDCCH) MAC CE.

The UE can receive an activation command based on the MAC CE that maps a codepoint of a DCI field “transmission configuration indication” to one or to two TCI states. For example, when a codepoint of the DCI TCI field is associated with two TCI states, one TCI state may be associated with TRP A and one TCI state may be associated with TRP B, respectively. In another example, a codepoint of the DCI TCI field for one or for two associated TCI states, may correspond to a TCI state from the first set of TCI states S1 or from the second set of TCI states S2 or to a combination of TCI states from the first and second set of TCI states S1 and S2 wherein a selection of a set of TCI states and/or a determination of a TCI state from a selected set of TCI states by the UE is based on the provided and/or indicated SBFD configuration.

When the UE is provided or indicated with an SBFD configuration for a symbol or a slot, the SBFD configuration may be provided to the UE using higher layer signaling, MAC-CE or DCI based signaling. For example, DCI based signaling may correspond to a unicast DCI or a groupcast or common DCI format. An SBFD configuration provided or indicated for a symbol or slot may be received in a different, e.g., earlier, symbol or slot than the symbol or slot for which the SBFD configuration is applied. The UE receives a DCI format with a TCI field that maps a codepoint to one or two TCI states. The UE determines if the first or the second SBFD configuration is applied to the symbol or the slot with respect to the TCI field.

The UE further determines the associated set TCI states based on the provided or indicated SBFD configuration for the symbol or the slot. For example, if the first SBFD configuration of type “DUD” is indicated to the UE, the UE selects the associated first subset of N1 TCI states linked with the first SBFD configuration. For example, if the second SBFD configuration of type “none” is indicated to the UE, the UE selects the associated second subset of N2 TCI states linked with the second SBFD configuration. The UE further determines a TCI state from the selected set of TCI states based on the codepoint in the TCI field of the DCI.

For example, if the indicated TCI state is from the first subset of N1 TCI states liked to the first SBFD configuration of type “DUD,” the UE may not consider valid a PDSCH or PDCCH resource allocation if the PDSCH or PDCCH frequency-domain allocation comprises RBs in an SBFD UL subband of the first SBFD configuration. The UE may configure its reception filtering setting based on the known frequency-domain location of the SBFD DL subbands based on the first SBFD configuration for reception of the DCI with a TCI field. For example, if the indicated TCI state is from the second subset of N2 TCI states, the UE may consider valid any PDSCH or PDCCH resource allocation.

The UE may configure its reception filtering setting based on the active UE DL BWP based on the second SBFD configuration for reception of the DCI with a TCI field. A suitable activation delay, validity duration or reference symbol for an SBFD configuration associated with the indication of a TCI state or a set of TCI states for a DCI with a TCI field on a symbol may be used. An activation delay, validity duration or reference symbol for the SBFD configuration associated with a set of TCI states may be a same or may be different with respect to a beam activation delay and/or minimum processing requirement.

For example, when the UE receives a DCI format with a TCI field that maps a codepoint to one or to two TCI states, e.g., for simultaneous update of the TCI states for TRP A and TRP B, the UE may determine a TCI state from the first and/or the second associated set of TCI states based on the first and/or the second SBFD configuration. For example, the UE may determine that a superset or a subset or a joint or a restricted set of TCI states from the first and/or the second set of TCI states is indicated by a codepoint of the TCI field in a DCI. For example, when the first and the second set of TCI states are linked to a different SBFD configuration for TRP A and TRP B, respectively, a suitable rule such as based on a reference configuration, a priority, a ranking, a list or order based on more than one SBFD configurations and/or SBFD subband type may be used to further determine the UE processing assumptions for receiving the TCI field in a DCI. For example, when the first SBFD configuration of type “DUD” is configured as reference configuration or configured with a higher priority than the second SBFD configuration of type “none,” the UE selects the first set of TCI states for interpretation of the TCI field in a DCI on the symbol or slot and determines a TCI state based on the first set.

A motivation for UE determination of an associated set of TCI states based on SBFD configurations is support for SBFD for UE operation across TRP A with and TRP B without SBFD support or across TRP A and TRP B with SBFD support but benefiting from separate SBFD configuration for ease of deployment and inter-operability. Another motivation is increased gNB scheduling flexibility for SBFD operation when higher-layer or DCI-based signaling to provide or indicate an SBFD configuration to a UE is available. The UE can determine the associated set of TCI states with respect to receptions from TRP A or TRP B based on the provided or indicated SBFD symbol or slot configuration.

In one example, a set of N TCI states are associated with an SBFD configuration is configured by RRC. Multiple sets of TCI states, e.g., set S1 and set S2, can be provided to the UE. Existing MAC CE signaling can include a subset of M (M≤N) TCI states or TCI state code points from the set of N TCI states, wherein a code point is signaled in the “transmission configuration indication” field of a DCI used for indication of the TCI state wherein a codepoint can map to one or to two TCI states. A new extended TCI field of length L′>3 bits can be used. Alternatively, an existing first TCI field of length L=3 bits is reused, and a new second TCI field of length L′>0 bits can be used. A motivation is a reduced UE modem design delta and a reduced specification impact when the existing DCI TCI field for indication of TCI states and/or MAC-CE based signaling to (de-)activate TCI states can be reused while allowing the UE to determine the set of TCI states associated with an SBFD configuration of a TRP based on existing L1 signaling. Association of a set of TCI states with an SBFD configuration occurs in higher protocol layers.

In one example, one or more sets of TCI states, e.g., set S1 and set S2, are associated with an SBFD configuration. For simplicity, it is assumed that a set S1 and S2 of TCI states are configured with N1 and N2 TCI states, respectively by RRC. New MAC CE signaling can include an indication for one or more sets of TCI states or indicate a subset of M (M≤(N1+N2)) TCI states from either one or combination of sets of TCI states. The provided or indicated SBFD configuration is then used by the UE to determine the subset of M TCI states or TCI state code points with resulting TCI states from either one set S1 or set S2 or both, wherein a code point is signaled in the “transmission configuration indication” field of a DCI and a codepoint of the TCI field can map to one or to two TCI states. An existing TCI field of length L=3 bits can be reused, or a new extended TCI field of length L′>3 bits can be used. Alternatively, an existing first TCI field of length L=3 bits is reused, and a new second TCI field of length L′>0 bits can be used. A motivation is increased signaling flexibility in RRC_CONNECTED mode to activate or de-active from a candidate set of TCI states associated with one of multiple candidate SBFD configurations.

In one example, the UE determines a set of TCI states for PDCCH receptions based on a first SBFD configuration and determines a set of TCI states for PDSCH receptions based on a second SBFD configuration. The set of TCI states for PDCCH reception from a TRP associated with an SBFD configuration and the set of TCI states for PDSCH receptions from the TRP associated with an SBFD configuration can then be the same or can be different.

In one example, an SBFD configuration which provides an association for the set of TCI states for receptions by the UE is applied by the UE from the same symbol and/or for the number of symbols for which the SBFD configuration is provided and/or indicated.

In one example, when the UE determines different SBFD configurations on a symbol/slot for transmissions to and/or receptions from TRP A and TRP B, respectively, the UE further determines the transmission direction on the symbol/slot based on a default or a provided reference, a priority, a ranking, or a list of the more than one SBFD configurations to select an associated set of TCI states. In an alternative example, the UE further determines an applicable SBFD configuration as subset, or as a superset based on the more than one SBFD configurations, to select an associated set of TCI states.

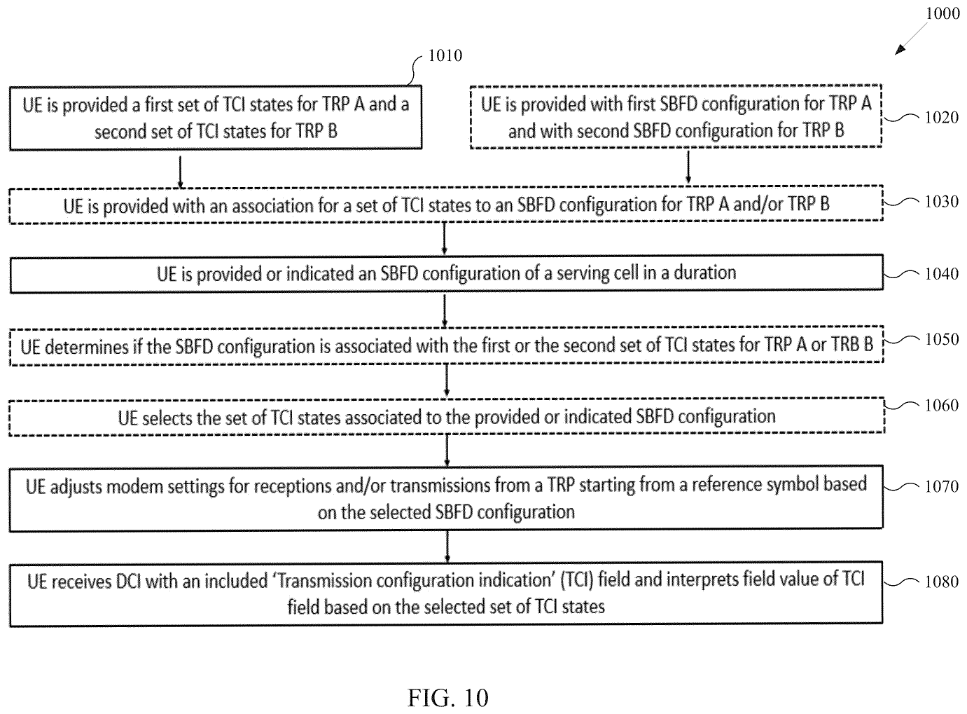

FIG. 10 illustrates a flowchart of UE method 1000 for a determination of a set of TCI states based on SBFD configuration for mTRP operation in a full-duplex communication system according to embodiments of the present disclosure. The UE method 1000 as may be performed by a UE (e.g., 111-116 as illustrated in FIG. 1). An embodiment of the UE method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, in step 1010, the UE is provided a first set of TCI states. In step 1020, the UE is provided with first SBFD configurations. In step 1030, the UE is provided with an association for a set of TCI states to an SBFD configuration for TRP A and/or TRP B. In step 1040, the UE is provided or indicated an SBFD configuration of a serving cell in duration. In step 1050, the UE determines if the SBFD configuration is associated with the first or the second set of TCI states for TRP A or TRP B. In step 1060, the UE selects the set of TCI states associated to the provided or indicated SBFD configuration. In step 1070, the UE adjusts modem settings for reception and/or transmission. In step 1080, the UE receives DCI with an included TCI field and interprets field value of TCI field based on the selected set of TCI states.

In one embodiment, a UE provides a UE capability indication to the gNB that the UE only supports transmissions to and/or receptions from multiple TRPs for a configured and/or an indicated SBFD configuration based on a restricted SBFD or a restricted TCI state configuration.

For example, a restricted SBFD or TCI state configuration supported by a UE with respect to transmissions to and receptions from TRP A and TRP B when compared to an SBFD or TCI state configuration supported by the UE for the case of single TRP operation may correspond to one or a combination of the following examples of restrictions.

In one example, an SBFD frequency-domain restriction on a symbol/slot such as an SBFD configuration type for the symbol/slot, e.g., from the set {“DU,” “UD,” “DUD” }, a maximum number of configurable SBFD subbands on a symbol/slot, a maximum or a minimum or a value for a supported allocation bandwidth size of an SBFD subband on the symbol/slot.

In another example, an SBFD time-domain restriction such as a maximum configurable number of non-SBFD and/or SBFD symbols, respectively, in a duration with respect to non-SBFD and/or SBFD symbols for TRP A, for TRP B or for TRP and TRP B, in the duration.

In yet another example, an SBFD subband type restriction, e.g., a supported or not supported SBFD subband type from one or a combination of types such as {“SBFD DL subband,” “SBFD UL subband,” “SBFD Flexible subband” }.

In yet another example, an SBFD restriction of general type such as support of a single same SBFD configuration in frequency- and/or time-domain for TRP A and TRP B or such as a maximum number of different supported SBFD configurations configured and/or indicated with respect to TRP A and TRP B, wherein a same or a different SBFD configuration with respect to TRP A and TRP B may correspond to a frequency-domain allocation and/or a time-domain allocation of an SBFD configuration, or such as support of SBFD operation for intra-cell and/or inter-cell mTRP.

In yet another example, an SBFD signaling restriction such as support for RRC configured SBFD configuration only for TRP A and TRP B but no support for L1 or MAC-CE based indication of an SBFD configuration for a symbol/slot.

In yet another example, an SBFD processing restriction, e.g., a reduced number of default or concurrently active or maximum configurable TCI states for the UE for reception of a DL signal or channel such as PDCCH or PDSCH or CSI-RS, or spatial filters for transmission of a UL channel or signal, when compared to the single TRP case.

In one example, the UE does not support transmissions to and/or receptions from multiple TRPs when provided with an SBFD configuration by higher layer signaling and/or DCI or MAC-CE. The UE may support SBFD operation when not configured for mTRP operation and is configured for single TRP operation.

For example, the UE can provide a UE capability indication to the gNB that the UE does not support transmissions to and/or receptions from multiple TRPs when provided with an SBFD configuration.

For example, when the UE is provided a parameter sbfd-config, the UE expects to not be provided with a coresetPoolIndex, or the UE expects to be provided with a value of coresetPoolIndex which is the same for all CORESETs (e.g., equal to 0) if coresetPoolIndex is provided for some CORESETs. For example, when the UE is provided a parameter sbfd-config, the UE does not expect to be provided with simultaneousTCI-UpdateList1 or simultaneousTCI-UpdateList2 for up to two lists of cells for simultaneous TCI state activation.

In one example, the UE supports transmissions to and/or receptions from multiple TRPs based on an SBFD subband type restriction. For example, an SBFD subband type restriction may correspond to an SBFD configuration of type “DU” or “UD” on a symbol or slot. For example, the UE may support an SBFD configuration of type “DUD” when provided with an SBFD configuration for transmissions/receptions from/to an gNB, but only support an SBFD configuration of type “DU” or “UD” when the UE is configured for transmissions to and/or receptions from multiple TRPs.

For example, the UE can provide a UE capability indication to the gNB that the UE supports transmissions to and/or receptions from multiple TRPs based on an SBFD subband type restriction. For example, a UE capability indication associated with support of an SBFD subband type restrictions for TRP A and TRP, respectively, may correspond to an SBFD configuration of type “DU” or “UD” on a symbol or slot.

For example, if the UE is provided with parameter coresetPoolIndex with a value 0 for a first CORESET and a value 1 for a second CORESET, the UE does not expect to be provided with a same parameter sbfd-config for receptions from a cell based on the first or the second CORESET indicating more than one SBFD DL or UL subband on a symbol/slot. For example, when the UE is provided with simultaneousTCI-UpdateList1 or simultaneousTCI-UpdateList2 for up to two lists of cells for simultaneous TCI state activation, the UE does not expect to be provided with a same parameter sbfd-config indicating more than one SBFD DL or UL subband on a symbol/slot for the up to two lists of cells or for receptions from the up to two lists of cells.

In one example, the UE supports transmissions to and/or receptions from multiple TRPs based on an SBFD restriction of general type wherein a same SBFD configuration is expected by the UE for TRP A and TRP B, respectively.

For example, the UE can provide a UE capability indication to the gNB that the UE supports transmissions to and/or receptions from multiple TRPs based on a same SBFD configuration provided for the TRPs, e.g., for TRP A and TRP B, respectively. For example, a UE capability indication associated with support of a same SBFD configuration for TRP A and TRP B, respectively, may further correspond to a same frequency-domain SBFD configuration on a symbol/slot or a same time-domain SBFD configuration in a duration or a same frequency- and time-domain SBFD configuration.

For example, if the UE is provided with parameter coresetPoolIndex with a value 0 for a first CORESET and a value 1 for a second CORESET, the UE does not expect to be provided with different parameters sbfd-config for receptions from a cell based on the first or the second CORESET, e.g., the UE may assume a same parameter sbfd-config. For example, when the UE is provided with simultaneousTCI-UpdateList1 or simultaneousTCI-UpdateList2 for up to two lists of cells for simultaneous TCI state activation, the UE does not expect to be provided with different parameters sbfd-config for the up to two lists of cells or for receptions from the up to two lists of cells, e.g., the UE may assume a same parameter sbfd-config.

In one example, the UE supports transmissions to and/or receptions from multiple TRPs based on different SBFD configurations provided for the TRPs, e.g., for TRP A and TRP B, respectively, based on an SBFD restriction of general type with a maximum number of configured/indicated SBFD configurations. For example, the UE can support different SBFD configurations for TRP A and TRP B, respectively, or may support a same frequency-domain SBFD configuration on a symbol or slot but different time-domain SBFD configurations for TRP A and TRP B, or may support a different frequency-domain SBFD configuration on a symbol or slot for TRP A and TRP B, respectively, but a same time-domain SBFD configuration for TRP A and TRP-B, or may support both different frequency- and time-domain SBFD configurations for TRP A and TRP B, respectively. The UE may only support a maximum number L_{mTRP} of different SBFD configurations.

For example, the UE can provide a UE capability indication to the gNB that the UE supports transmissions to and/or receptions from multiple TRPs based on different SBFD configurations provided for the TRPs, e.g., for TRP A and TRP B, respectively, for a maximum number L_{mTRP} of different SBFD configurations. For example, a UE capability indication associated with support of different SBFD configurations for TRP A and TRP B, respectively, may correspond to support of a same frequency-domain SBFD configuration on a symbol or slot but different time-domain SBFD configurations for TRP A and TRP B, or may correspond to support of a different frequency-domain SBFD configuration on a symbol or slot for TRP A and TRP B, respectively, but a same time-domain SBFD configuration for TRP A and TRP B, or may correspond to support of both different frequency- and time-domain SBFD configurations for TRP A and TRP B, respectively.

For example, if the UE is provided with parameter coresetPoolIndex with a value 0 for a first CORESET and a value 1 for a second CORESET, the UE does not expect to be provided with a parameter sbfd-config for receptions from a cell based on the first or the second CORESET indicating a different frequency-domain allocation of an SBFD DL or UL subband on a symbol/slot with respect to the coresetPoolIndex with value 0 or with value 1. For example, when the UE is provided with simultaneousTCI-UpdateList1 or simultaneousTCI-UpdateList2 for up to two lists of cells for simultaneous TCI state activation, the UE does not expect to be provided with a parameter sbfd-config indicating a different frequency-domain allocation of an SBFD DL or UL subband on a symbol/slot with respect to the up to two lists of cells or for receptions from the up to two lists of cells.

For example, if the UE is provided with parameter coresetPoolIndex with a value 0 for a first CORESET and a value 1 for a second CORESET, the UE does not expect to be provided with a parameter sbfd-config for receptions from a cell based on the first or the second CORESET indicating a different time-domain allocation of an SBFD DL or UL subband on a symbol/slot with respect to the coresetPoolIndex with value 0 or with value 1. For example, when the UE is provided with simultaneousTCI-UpdateList1 or simultaneousTCI-UpdateList2 for up to two lists of cells for simultaneous TCI state activation, the UE does not expect to be provided with a parameter sbfd-config indicating a different time-domain allocation of an SBFD DL or UL subband on a symbol/slot with respect to the up to two lists of cells or for receptions from the up to two lists of cells.

In one example, the UE supports transmissions to and/or receptions from multiple TRPs based on a same or different SBFD configuration provided for the TRPs, e.g., for TRP A and TRP B, respectively, with an SBFD processing restriction. For example, the UE can support the SBFD configurations for TRP A and TRP B, respectively, but receptions from TRP A and TRP B occur in separate SBFD subbands. For example, the UE can support an SBFD configurations of type “DUD” when provided with SBFD configurations for transmissions to and/or receptions from multiple TRP but CORESETs of a coresetPoolIndex with a first value, e.g., 0, are allocated in the first SBFD DL subband while the CORESETs of a coresetPoolIndex with a second value, e.g., 1, are allocated in the second SBFD DL subband or an SBFD UL subband for an SBFD type “DUD” configuration.

For example, the UE can provide a UE capability indication to the gNB that the UE supports transmissions to and/or receptions from multiple TRPs based on SBFD configurations provided for the TRPs, e.g., for TRP A and TRP B, respectively, with an SBFD processing restriction. For example, a UE capability indication associated with support of SBFD configurations for TRP A and TRP B, respectively, may correspond to a number L_{SB} of SBFD subbands allowed for reception from a TRP A and TRP B, respectively. For example, the UE may support an SBFD configuration of type “DUD” when provided with an SBFD configuration for transmissions/receptions from/to an gNB, but when the UE is configured for transmissions to and/or receptions from multiple TRPs for which SBFD configurations are provided to the UE, receptions from TRP A and TRP B are restricted to separate SBFD subbands, e.g., SBFD DL subband 1 and SBFD DL subband 2, on a symbol/slot, respectively.

For example, if the UE is provided with parameter coresetPoolIndex with a value 0 for a first CORESET, and a value 1 for a second CORESET, the UE does not expect to be provided with a parameter sbfd-config for receptions from a cell based on the first or the second CORESET, respectively, with a frequency-domain allocation of the first and the second CORESET in a same SBFD DL subband on a symbol/slot. For example, when the UE is provided with simultaneousTCI-UpdateList1 or simultaneousTCI-UpdateList2 for up to two lists of cells for simultaneous TCI state activation, the UE does not expect to be provided with a parameter sbfd-config for a cell from the first list of cell and a cell from the second list of cells, respectively, associated with DL receptions from a cell from the first list of serving cells and a cell from the second list of serving cells in a same SBFD DL subband on a symbol/slot.

In one example, the UE supports transmissions to and/or receptions from multiple TRPs based on a same or different provided SBFD configurations provided for the TRPs, e.g., for TRP A and TRP B, respectively, with an SBFD processing restriction wherein the SBFD processing restriction corresponds to a number of supported SBFD subbands on symbols/slots in a duration. In one example, a number of supported SBFD subbands can be associated with a number of different SBFD subband types, e.g., SBFD DL subband, SBFD UL subband, SBFD flexible subband, provided to the UE on a symbol or slot. In one example, a number of SBFD subbands can be associated with a number of symbols or slots on which an SBFD subband of an SBFD subband type for TRP A or TRP B or for both TRP A and TRP B is supported by the UE for transmission and/or reception in a duration.

A duration may be suitably chosen, e.g., per slot, per subframe or for a reference time duration. In one example, a total number N of supported SBFD subbands in a duration can be associated with a first number N1 of SBFD subbands of an SBFD subband type on a symbol or slot and a second number N2 of SBFD symbols in a duration. For example, the UE may indicate a capability that the UE can support N=40, e.g., using N1=2 SBFD DL subbands with “DUD” on a symbol for N2=20 SBFD symbols with this same configuration, or using N1=2 SBFD DL subbands with “DUD” on a symbol for N2=10 symbols and N1=1 SBFD DL subbands with “DU” on N3=20 symbols.

For example, the UE can provide a UE capability indication to the gNB that the UE supports transmissions to and/or receptions from multiple TRPs based on a same or different provided SBFD configurations provided for the TRPs, e.g., for TRP A and TRP B, respectively, for a number of supported SBFD subbands. In one example, a number of supported SBFD subbands of the UE capability can be associated with a number of different SBFD subband types, e.g., SBFD DL subband, SBFD UL subband, SBFD flexible subband, provided to the UE on a symbol or slot. In one example, a number of SBFD subbands in the UE capability can be associated with a number of symbols or slots of on which an SBFD subband of an SBFD subband type for TRP A, or TRP B, or for both TRP A and TRP B is supported by the UE for transmission and/or reception in a duration.

For example, if the UE is provided with parameter coresetPoolIndex with a value 0 for a first CORESET and a value 1 for a second CORESET, the UE does not expect to be provided with a parameter sbfd-config for receptions from a cell based on the first or the second CORESET, respectively, resulting in more than a number N of potential SBFD DL subband receptions or potential SBFD UL subband transmissions in a duration wherein the number N is determined by the UE processing capability. For example, when the UE is provided with simultaneousTCI-UpdateList1 or simultaneousTCI-UpdateList2 for up to two lists of cells for simultaneous TCI state activation, the UE does not expect to be provided with a parameter sbfd-config for a cell from the first list of cell and a cell from the second list of cells, respectively resulting in more than a number N of potential SBFD DL subband receptions or potential SBFD UL subband transmissions in a duration for the up to two lists of cells or for receptions from the up to two lists of cells wherein the number N is determined by the UE processing capability.

In one example, the UE supports transmissions to and/or receptions from multiple TRPs based on a same or different provided SBFD configurations based on an SBFD restriction of general type wherein the restriction is SBFD support by the UE for the intra-cell TRP case only, e.g., when the UE is not configured with an SSB associated with a PCI which is different from the serving cell PCI or additional PCI.

For example, the UE can provide a UE capability indication to the gNB that the UE supports transmissions to and/or receptions from multiple TRPs based on a same or different provided SBFD configurations for the intra-cell TRP case only, e.g., when the UE is not configured with an SSB associated with a PCI which is different from the serving cell PCI or additional PCI.

For example, if the UE is provided with a parameter additionalPCI, the UE does not expect to be provided with a parameter sbfd-config.

In one example, the UE supports transmissions to and/or receptions from multiple TRPs with inter-cell TRP operation with an SBFD restriction of general type wherein the SBFD restriction is associated with use of a same provided SBFD configuration for the TRPs, e.g., for TRP A and TRP B, respectively, when the UE is provided with an additional PCI.

For example, the UE can provide a UE capability indication to the gNB that the UE supports transmissions to and/or receptions from multiple TRPs for inter-cell TRP operation based on a same provided SBFD configuration for the TRPs, e.g., for TRP A and TRP B, respectively, when the UE is provided with an additional PCI.

For example, if the UE is provided with a parameter additionalPCI and the UE is provided with parameter coresetPoolIndex which has a value 0 for a first CORESET, and has a value 1 for a second CORESET, the UE does not expect to be provided with different parameters sbfd-config for receptions from a cell based on the first or the second CORESET, e.g., the UE may assume a same value for parameter sbfd-config. For example, if the UE is provided with a parameter additionalPCI and the UE is provided with simultaneousTCI-UpdateList1 or simultaneousTCI-UpdateList2 for up to two lists of cells for simultaneous TCI state activation, the UE does not expect to be provided with different parameters sbfd-config for the up to two lists of cells or for receptions from the up to two lists of cells, e.g., the UE may assume a same parameter sbfd-config.

In another example, the UE supports transmissions to and/or receptions from multiple TRPs based on a different provided SBFD configuration for the TRPs, e.g., for TRP A and TRP B, respectively, for inter-cell TRP operation, e.g., when the UE is provided with an additional PCI.

For example, the UE can provide a UE capability indication to the gNB that the UE supports transmissions to and/or receptions from multiple TRPs based on a different provided SBFD configuration for the TRPs, e.g., for TRP A and TRP B, respectively, for inter-cell TRP operation, e.g., when the UE is provided with an additional PCI.

In one example, the UE supports transmissions to and/or receptions from multiple TRPs based on a same or different SBFD configurations provided for the TRPs, e.g., for TRP A and TRP B, respectively, based on an SBFD signaling restriction wherein the SBFD signaling restriction corresponds to SBFD configuration by higher layers only. For example, the UE supports transmissions to and/or receptions from TRP A and/or TRP-B when the SBFD configurations are configured by higher layers, but the UE does not support a change of a transmission direction based on an indication received by DCI or in a MAC-CE which would change or assign the transmission direction of a configured SBFD subband on a symbol or slot of the SBFD configuration.

For example, the UE can provide a UE capability indication to the gNB that the UE supports transmissions to and/or receptions from multiple TRPs based on a same or different SBFD configurations provided for the TRPs, e.g., for TRP A and TRP B, respectively, by higher layers only. For example, using this UE capability, the UE indicates that the UE supports transmissions to and/or receptions from TRP A and/or TRP B when the SBFD configurations are provided using higher layer signaling, such as RRC signaling, but the UE does not adjust an SBFD configuration based on an indication received by the UE in a DCI or in a MAC-CE which would change or assign another transmission direction of a configured SBFD subband on a symbol or slot.

For example, the UE considers symbols in a slot indicated as SBFD DL subband by sbfd-config to be available for receptions and considers symbols in a slot indicated as SBFD UL subband by sbfd-config to be available for transmissions if the UE is provided with parameter coresetPoolIndex with a value 0 for a first CORESET and a value 1 for a second CORESET, or when the UE is provided with simultaneousTCI-UpdateList1 or simultaneousTCI-UpdateList2 for up to two lists of cells for simultaneous TCI state activation. For a set of symbols of a slot or a set of RBs on a symbol for which parameter sbfd-config is provided and indicates an SBFD DL subband, a UE does not expect to detect a DCI format indicating an UL transmission. For a set of symbols of a slot or a set of RBs on a symbol for which parameter sbfd-config is provided and indicates an SBFD UL subband, a UE does not expect to detect a DCI format indicating a DL reception.

A motivation for UE support for transmissions to and/or receptions from multiple TRPs based on a restricted SBFD configuration is a reduced UE modem complexity, a faster UE processing timeline and a better radio range. For example, when a same restricted frequency-domain configuration of an SBFD DL or UL subband is provided to the UE transmissions to and receptions from TRP A and from TRP B, respectively, the same UE Tx and/or Rx filter setting can then be selected by the UE for receptions in an SBFD DL subband and for transmissions from the UE in an SBFD UL subband. Therefore, inter-subband interference rejection can be increased, and radio range can be improved. For example, when multi-TRP operation for the inter-cell TRP case does not need to be supported by the UE, fewer SSB-based measurements associated with the parameter additionalPCIneed to be performed by the UE and a number of UE processes is reduced for processing the received SSBs in presence of the SBFD configuration, e.g., SBFD UL subband, on the SSB symbols for two cells.

For example, the UE may provide a capability information or indicate to a gNB if the UE supports transmissions to and/or receptions from/to multiple TRPs based on a restricted SBFD configuration based on UE radio access capability parameters and/or based on a mandatory or an optional feature group. For example, the UE may include capability information as an IE in an RRC UECapabilityInformation message. A gNB may solicit or request reporting from the UE associated with the UE support of an SBFD configurations for multi-TRP operation in an RRC UECapabilityEnquiry message. A UE capability associated with a support and/or a restriction of SBFD configuration associated with multi-TRP operation may further distinguish and separately indicate a UE support for a frequency range (FR) or for a band, or for a band combination, or be provided in combination with or can be co-dependent with respect to other features such as a MIMO support on a band or for a band combination.

For example, one or more feature groups (FGs) associated with UE support using one or multiple provided SBFD configurations for transmissions to and/or receptions from multiple TRPs and/or a restriction may be provided by 3GPP standard specification. For example, a first FG may indicate UE support for transmissions to and/or receptions from multiple TRPs based on a same provided SBFD configuration provided for the TRPs, e.g., for TRP A and TRP B, respectively. For example, a second FG may indicate UE support for transmissions to and/or receptions from multiple TRPs based on a different provided SBFD configuration provided for the TRPs, e.g., for TRP A and TRP B, respectively, if a same frequency-domain configuration of an SBFD DL or UL subband is provided by the SBFD configurations for TRP A and TRP B, respectively. An FG may be included or be part of a default feature set or feature set group for which the UE indicates support to the network during connection establishment or when solicited by the network.

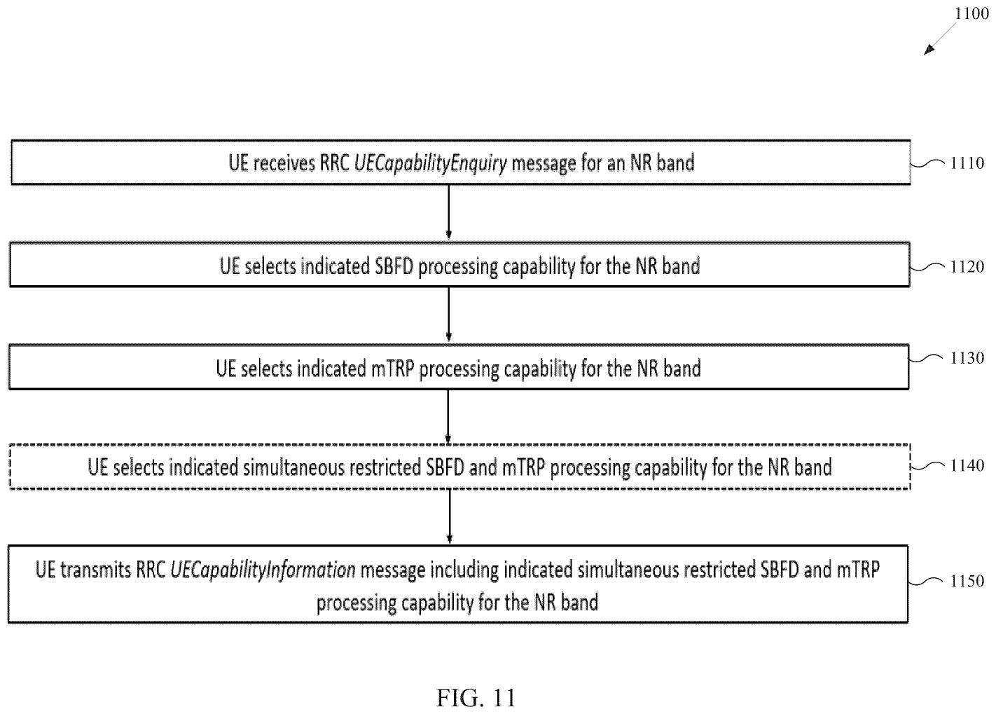

FIG. 11 illustrates a flowchart of UE method 1100 for an indication of restricted SBFD configuration for mTRP operation in a full-duplex communication system according to embodiments of the present disclosure. The UE method 1100 as may be performed by a UE (e.g., 111-116 as illustrated in FIG. 1). An embodiment of the UE method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, in step 1110, the UE receives RRC UECapabilityEnquiry message for an NR band. In step 1120, the UE selects indicated SBFD processing capability for the NR band. In step 1130, the UE selects indicated mTRP processing capability for the NR band. In step 1140, the UE selects indicated simultaneous restricted SBFD and mTRP processing capability for the NR band. In step 1150, the UE transmits RRC UECapabilityinformation message including indicated simultaneous restricted SBFD and mTRP processing capability for the NR band.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of operating a user equipment (UE), the method comprising:
receiving a first candidate subband full-duplex (SBFD) configuration associated with a first transmission configuration indicator (TCI) state configuration on a cell;
receiving a second candidate SBFD configuration associated with a second TCI state configuration on the cell;
identifying a TCI state code point;
selecting (i) the first candidate SBFD configuration when a value of the TCI state code point is associated with the first TCI state configuration or (ii) the second candidate SBFD configuration when the value of the TCI state code point is associated with the second TCI state configuration;
receiving or transmitting a channel or signal based on the selected SBFD configuration,
wherein the value of the TCI state code point is from a set of values associated with a set of transmit-receive points (TRPs).

2. The method of claim 1, further comprising receiving a downlink control information (DCI) format or a medium access control (MAC) layer control element (CE) that includes the TCI state code point.

3. The method of claim 1, wherein:
a first TCI state code point from the first TCI state configuration or a second TCI state code point from the second TCI state configuration includes:
a downlink (DL) TCI state,
an uplink (UL) TCI state,
a joint TCI state, or
a pair of a DL TCI state and an UL TCI state; and
a TCI state includes a source reference signal for quasi-colocation or a source reference signal for spatial information.

4. The method of claim 1, further comprising:
receiving a physical downlink shared channel (PDSCH) configuration;
determining a downlink (DL) reception parameter in a slot or symbol for a PDSCH reception instance based on the selected SBFD configuration; and
receiving the PDSCH based on the DL reception parameter.

5. The method of claim 1, further comprising:
receiving a physical uplink shared channel (PUSCH) configuration;
determining an uplink (UL) transmission parameter in a slot or symbol for a PUSCH transmission instance based on the selected SBFD configuration; and
transmitting the PUSCH based on the UL transmission parameter.

6. The method of claim 1, wherein:
the first candidate SBFD configuration or the second candidate SBFD configuration includes a frequency-domain restriction for transmissions associated with the set of TRPs, and
a transmission of a physical uplink shared channel (PUSCH) is allowed on a TRP in the set of TRPs when a frequency-domain allocation of the PUSCH is within a range of the frequency-domain restriction.

7. The method of claim 1, wherein:
the first candidate SBFD configuration or the second candidate SBFD configuration includes a frequency-domain restriction for receptions associated with the set of TRPs, and
a reception of a physical downlink shared channel (PDSCH) is allowed on a TRP in the set of TRPs when a frequency-domain allocation of the PDSCH is within a range of the frequency-domain restriction.

8. A user equipment (UE), comprising:
a transceiver configured to:
receive a first candidate subband full-duplex (SBFD) configuration associated with a first transmission configuration indicator (TCI) state configuration on a cell; and
receive a second candidate SBFD configuration associated with a second TCI state configuration on the cell; and
a processor operably coupled to the transceiver, the processor configured to:
identify a TCI state code point; and
select (i) the first candidate SBFD configuration when a value of the TCI state code point is associated with the first TCI state configuration or (ii) the second candidate SBFD configuration when the value of the TCI state code point is associated with the second TCI state configuration,
wherein the transceiver is further configured to receive or transmit a channel or signal based on the selected SBFD configuration, and
wherein the value of the TCI state code point is from a set of values associated with a set of transmit-receive points (TRPs).

9. The UE of claim 8, wherein the transceiver is further configured to receive a downlink control information (DCI) format or a medium access control (MAC) layer control element (CE) that includes the TCI state code point.

10. The UE of claim 8, wherein:
a first TCI state code point from the first TCI state configuration or a second TCI state code point from the second TCI state configuration includes:
a downlink (DL) TCI state,
an uplink (UL) TCI state,
a joint TCI state, or
a pair of a DL TCI state and an UL TCI state; and
a TCI state includes a source reference signal for quasi-colocation or a source reference signal for spatial information.

11. The UE of claim 8, wherein:
the transceiver is further configured to receive a physical downlink shared channel (PDSCH) configuration;
the processor is further configured to determine a downlink (DL) reception parameter in a slot or symbol for a PDSCH reception instance based on the selected SBFD configuration; and
the transceiver is further configured to receive the PDSCH based on the DL reception parameter.

12. The UE of claim 8, wherein:
the transceiver is further configured to receive a physical uplink shared channel (PUSCH) configuration;
the processor is further configured to determine an uplink (UL) transmission parameter in a slot or symbol for a PUSCH transmission instance based on the selected SBFD configuration; and
the transceiver is further configured to transmit the PUSCH based on the UL transmission parameter.

13. The UE of claim 8, wherein:
the first candidate SBFD configuration or the second candidate SBFD configuration includes a frequency-domain restriction for transmissions associated with the set of TRPs, and
a transmission of a physical uplink shared channel (PUSCH) is allowed on a TRP in the set of TRPs when a frequency-domain allocation of the PUSCH is within a range of the frequency-domain restriction.

14. The UE of claim 8, wherein:
the first candidate SBFD configuration or the second candidate SBFD configuration includes a frequency-domain restriction for receptions associated with the set of TRPs, and
a reception of a physical downlink shared channel (PDSCH) is allowed on a TRP in the set of TRPs when a frequency-domain allocation of the PDSCH is within a range of the frequency-domain restriction.

15. A base station (BS), comprising:
a processor; and
a transceiver operably coupled to the processor, the transceiver configured to:
transmit a first candidate subband full-duplex (SBFD) configuration associated with a first transmission configuration indicator (TCI) state configuration on a cell; and
transmit a second candidate SBFD configuration associated with a second TCI state configuration on the cell; and
receive or transmit a channel or signal associated with a SBFD configuration, and
wherein the SBFD configuration is from (i) the first candidate SBFD configuration when a value of a TCI state code point is associated with the first TCI state configuration or (ii) the second candidate SBFD configuration when the value of the TCI state code point is associated with the second TCI state configuration, and
wherein the value of the TCI state code point is from a set of values associated with a set of transmit-receive points (TRPs).

16. The BS of claim 15, wherein the transceiver is further configured to transmit a downlink control information (DCI) format or a medium access control (MAC) layer control element (CE) that includes the TCI state code point.

17. The BS of claim 15, wherein the transceiver is further configured to:
transmit a physical downlink shared channel (PDSCH) configuration that indicates a downlink (DL) parameter in a slot or symbol for a PDSCH reception instance; and
transmit the PDSCH based on the DL parameter.

18. The BS of claim 15, wherein the transceiver is further configured to:
transmit a physical uplink shared channel (PUSCH) configuration that indicates an uplink (UL) parameter in a slot or symbol for a PUSCH transmission instance; and
receive the PUSCH based on the UL parameter.

19. The BS of claim 15, wherein:
the first candidate SBFD configuration or the second candidate SBFD configuration includes a frequency-domain restriction for transmissions associated with the set of TRPs, and
a transmission of a physical uplink shared channel (PUSCH) is allowed on a TRP in the set of TRPs when a frequency-domain allocation of the PUSCH is within a range of the frequency-domain restriction.

20. The BS of claim 15, wherein:
the first candidate SBFD configuration or the second candidate SBFD configuration includes a frequency-domain restriction for receptions associated with the set of TRPs, and
a reception of a physical downlink shared channel (PDSCH) is allowed on a TRP in the set of TRPs when a frequency-domain allocation of the PDSCH is within a range of the frequency-domain restriction.
